(19) United States
(12) Patent Application Publication
(10) Pub. No.: US 2016/0231567 A1
(43) Pub. Date: Aug. 11, 2016

(54) Display System

(71) Applicants: Pasi Saarikko, Espoo (FI); Pasi Kostamo, Espoo (FI); Lauri Sainiemi, Espoo (FI); Tuomas Vallius, Espoo (FI)

(72) Inventors: Pasi Saarikko, Espoo (FI); Pasi Kostamo, Espoo (FI); Lauri Sainiemi, Espoo (FI); Tuomas Vallius, Espoo (FI)

(21) Appl. No.: 14/617,666

(22) Filed: Feb. 9, 2015

(51) Int. Cl. G02B 27/01; G02B 5/18; F21V 8/00

(52) U.S. Cl. CPC G02B 27/0172; G02B 6/0033; G02B 6/0016; G02B 5/1866; G02B 2027/0178; G02B 2027/011; G02B 2027/0125

(57) ABSTRACT

A display system comprises an optical waveguide and a light engine. The light engine generates multiple input beams which form a virtual image. An incoupling grating of the optical waveguide couples each beam into an intermediate grating of the waveguide, in which that beam is guided onto multiple splitting regions. The intermediate grating splits that beam at the splitting regions to provide multiple substantially parallel versions of that beam. Those multiple versions are coupled into an exit grating of the waveguide, in which the multiple versions are guided onto multiple exit regions. The exit grating diffracts the multiple versions of that beam outwardly. The multiple input beams thus cause multiple exit beams to exit the waveguide which form a version of the virtual image. The incoupling and intermediate gratings are substantially contiguous, separated by no more than 100 micrometres in width along a common border.

### BACKGROUND

Display systems can used to make a desired image visible to a user (viewer). Wearable display systems can be embodied in a wearable headset which is arranged to display an image within a short distance from a human eye. Such wearable headsets are sometimes referred to as head mounted displays, and are provided with a frame which has a central portion fitting over a user's (wearer's) nose bridge and left and right support extensions which fit over a user's ears. Optical components are arranged in the frame so as to display an image within a few centimetres of the user's eyes. The image can be a computer generated image on a display, such as a micro display. The optical components are arranged to transport light of the desired image which is generated on the display to the user's eye to make the image visible to the user. The display on which the image is generated can form part of a light engine, such that the image itself generates collimated lights beams which can be guided by the optical component to provide an image visible to the user.

Different kinds of optical components have been used to convey the image from the display to the human eye. These can include lenses, mirrors, optical waveguides, holograms and diffraction gratings, for example. In some display systems, the optical components are fabricated using optics that allows the user to see the image but not to see through this optics at the “real world”. Other types of display systems provide a view through this optics so that the generated image which is displayed to the user is overlaid onto a real world view. This is sometimes referred to as augmented reality.

Waveguide-based display systems typically transport light from a light engine to the eye via a TIR (Total Internal Reflection) mechanism in a waveguide (light guide). Such systems can incorporate diffraction gratings, which cause effective beam expansion so as to output expanded versions of the beams provided by the light engine. This means the image is visible over a wider area when looking at the waveguide's output than when looking at the light engine directly: provided the eye is within an area such that it can receive some light from substantially all of the expanded beams, the whole image will be visible to the user. Such an area is referred to as an eye box.

To maintain image quality, the structure of the waveguide can be configured in various ways to mitigate distortion of the transported light.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Nor is the claimed subject matter limited to implementations that solve any or all of the disadvantages noted in the background section.

A display system comprising an optical waveguide and a light engine is provided. The optical waveguide has an incoupling grating, an intermediate grating and an exit grating. The light engine is configured to generate multiple input beams. Each beam is substantially collimated and directed to the incoupling grating in a unique inward direction, whereby the multiple input beams form a virtual image. The intermediate and exit grating have widths substantially larger than the beams' diameters. The incoupling grating is arranged to couple each beam into the intermediate grating, in which that beam is guided onto multiple splitting regions of the intermediate grating in a direction along the width of the intermediate grating. The intermediate grating is arranged to split that beam at the splitting regions to provide multiple substantially parallel versions of that beam. Those multiple versions are coupled into the exit grating, in which the multiple versions are guided onto multiple exit regions of the exit grating. The exit regions lie in a direction along the width of the exit grating. The exit grating is arranged to diffract the multiple versions of that beam outwardly. The multiple input beams thus cause multiple exit beams to exit the waveguide which form a version of the virtual image. The incoupling and intermediate gratings are substantially contiguous, separated by no more than 100 micrometres in width along a common border.

Also provided is an optical waveguide for a display system which has an incoupling grating, an intermediate grating and an exit grating. The incoupling grating is arranged to receive multiple input beams, each beam being substantially collimated and directed to the incoupling grating in a unique inward direction, whereby the multiple input beams form a virtual image. The intermediate and exit grating have widths substantially larger than the beams' diameters. The incoupling grating is arranged to couple each beam into the intermediate grating, in which that beam is guided onto multiple splitting regions of the intermediate grating in a direction along the width of the intermediate grating. The intermediate grating is arranged to split that beam at the splitting regions to provide multiple substantially parallel versions of that beam which are coupled into the exit grating, in which the multiple versions are guided onto multiple exit regions of the exit grating, the exit regions lying in a direction along the width of the exit grating. The exit grating is arranged to diffract the multiple versions of that beam outwardly, the multiple input beams thus causing multiple exit beams to exit the waveguide which form a version of the virtual image. The incoupling and intermediate gratings are substantially contiguous, being separated by no more than 100 micrometres in width along a common border.

### BRIEF DESCRIPTION OF FIGURES

FIG. 1 shows a wearable display system;

FIG. 2A shows a plan view of part of the display system;

FIGS. 3A and 3B shows perspective and frontal view of an optical component;

FIG. 4A shows a schematic plan view of an optical component having a surface relief grating formed on its surface;

FIG. 4B shows a schematic illustration of the optical component of FIG. 4A, shown interacting with incident light and viewed from the side;

FIG. 5A shows a schematic illustration of a straight binary surface relief grating, shown interacting with incident light and viewed from the side;

FIG. 5B shows a schematic illustration of a slanted binary surface relief grating, shown interacting with incident light and viewed from the side;

FIG. 5C shows a schematic illustration of an overhanging triangular surface relief grating, shown interacting with incident light and viewed from the side;

FIG. 6 shows a close up view of part of an incoupling zone of an optical component;

FIG. 7A shows a perspective view of a part of a display system;

FIG. 7B shows a plan view of individual pixels of a display;

FIGS. 7C and 7D show plan and frontal views of a beam interacting with an optical component;

FIG. 7E shows a frontal view of an optical component performing beam expansion;

FIG. 7E shows a frontal view of an optical component performing beam expansion;

FIG. 7G is a plan view of a curved optical component;

FIGS. 8A and 8B are plan and frontal views of a part of an optical component;

FIG. 9A shows a perspective view of beam reflection within a fold zone of a waveguide;

FIG. 9B illustrates a beam expansion mechanism;

FIG. 10 shows a graph of MTF as function of gap width for an exemplary waveguide;

FIG. 11 shows a flow chart for a microfabrication process for manufacturing optical components or masters;

FIG. 12A shows an exemplary optical component having certain characteristics which may impact on image quality

FIG. 12B shows an exposure set-up which could be used in making the optical component of FIG. 12A;

### DETAILED DESCRIPTION

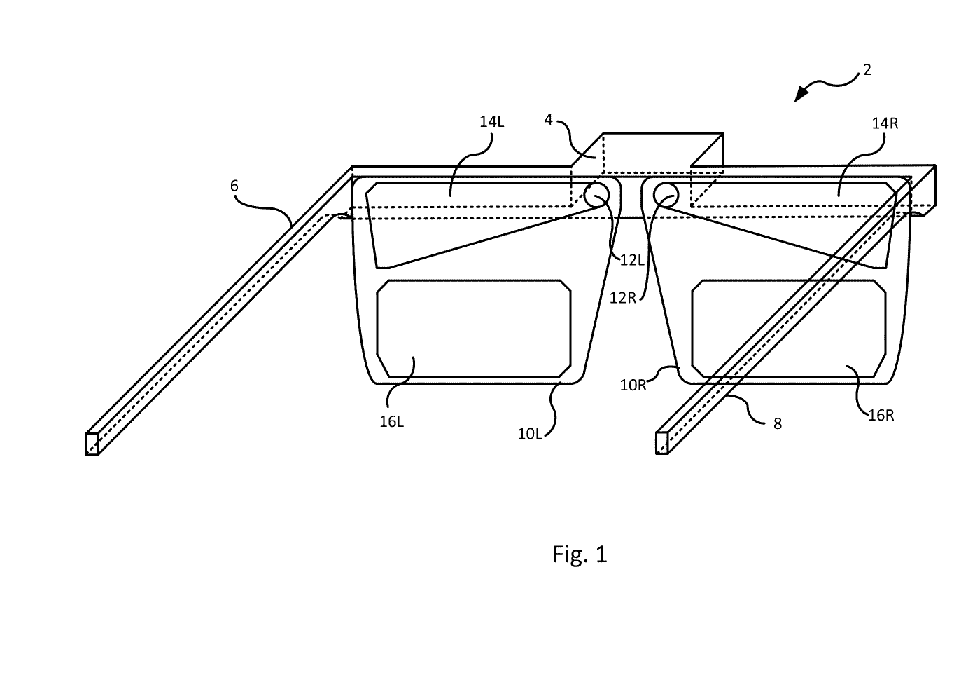

FIG. 1 is a perspective view of a head mounted display. The head mounted display comprises a headpiece, which comprises a frame 2 having a central portion 4 intended to fit over the nose bridge of a wearer, and a left and right supporting extension 6,8 which are intended to fit over a user's ears. Although the supporting extensions are shown to be substantially straight, they could terminate with curved parts to more comfortably fit over the ears in the manner of conventional spectacles.

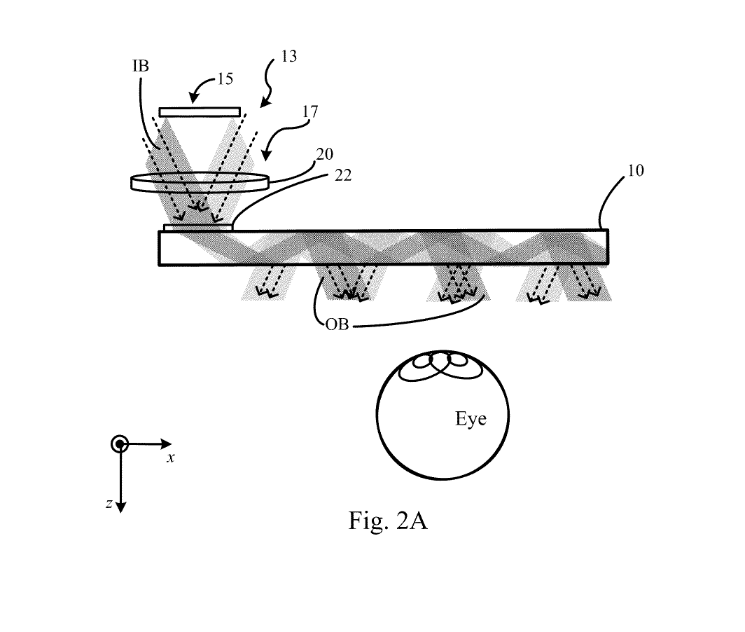

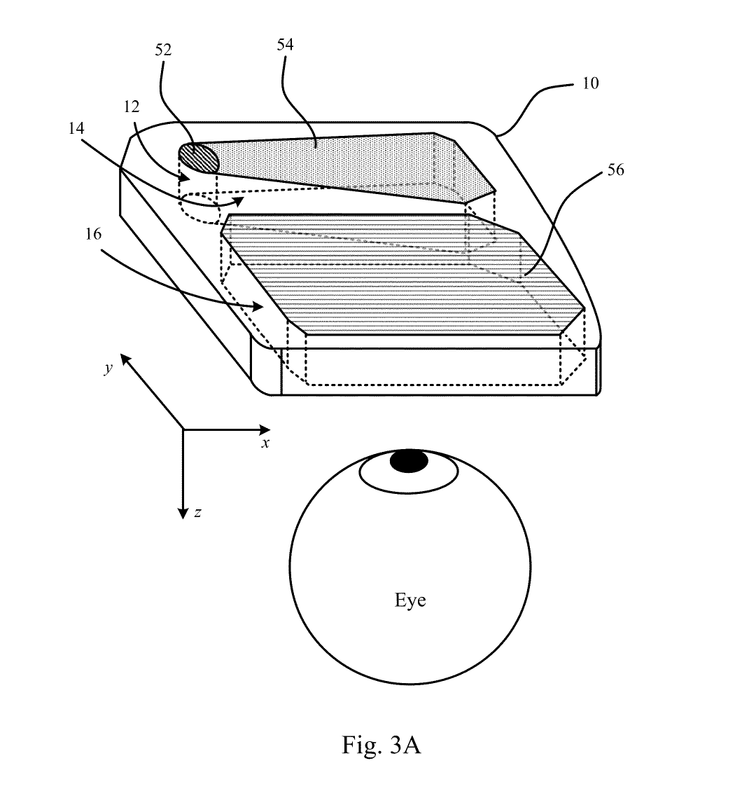

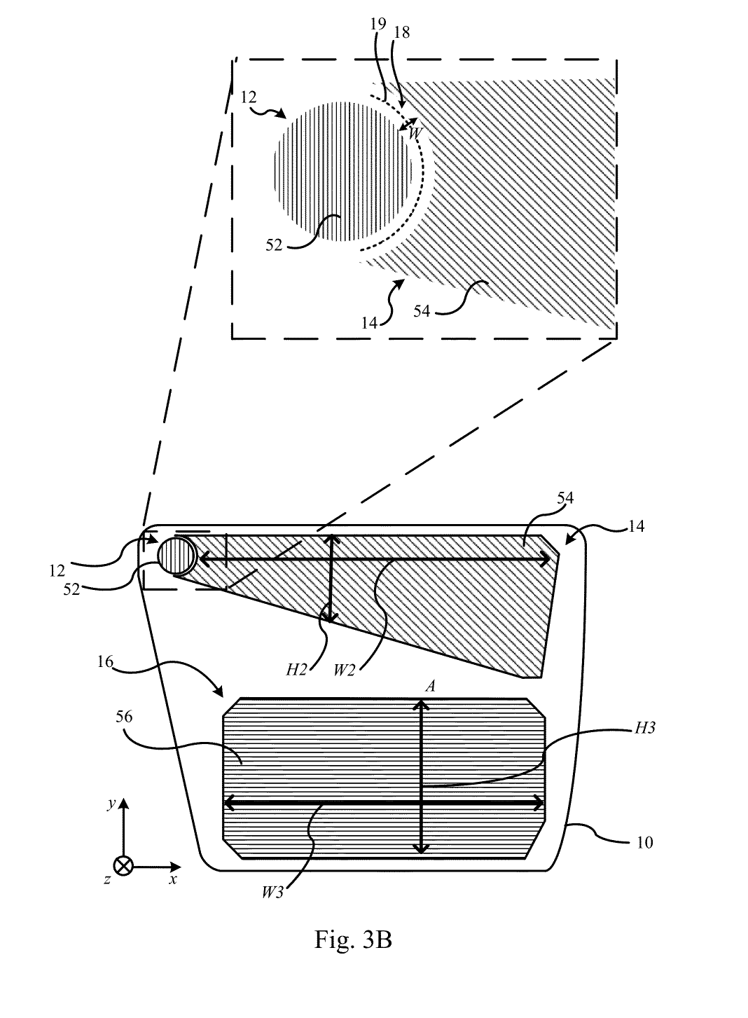

The frame 2 supports left and right optical components, labelled 10L and 10R, which are waveguides. For ease of reference herein an optical component 10 (optical waveguide 10) will be considered to be either a left or right component, because the components are essentially identical apart from being mirror images of each other. Therefore, all description pertaining to the left-hand component also pertains to the right-hand component. The optical components will be described in more detail later with reference to FIG. 3. The central portion 4 houses a light engine which is not shown in FIG. 1 but which is shown in FIG. 2.

FIG. 2 shows a plan view of a section of the top part of the frame of FIG. 1. Thus, FIG. 2 shows the light engine 13 which comprises a micro display 15 and imaging optics 17 in the form of a collimating lens 20. The light engine also includes a processor which is capable of generating an image for the micro display. The micro display can be any type of image source, such as liquid crystal on silicon (LCOS) displays, transmissive liquid crystal displays (LCD), matrix arrays of LED's (whether organic or inorganic) and any other suitable display. The display is driven by circuitry which is not visible in FIG. 2 which activates individual pixels of the display to generate an image. The substantially collimated light, from each pixel, falls on an exit pupil 22 of the light engine 13. At exit pupil 22, collimated light beams are coupled into each optical component, 10L, 10R into a respective in-coupling zone 12L, 12R provided on each component. These in-coupling zones are clearly shown in FIG. 1, but are not readily visible in FIG. 2. In-coupled light is then guided, through a mechanism that involves diffraction and TIR, laterally of the optical component in a respective intermediate (fold) zone 14L, 14R, and also downward into a respective exit zone 16L, 16R where it exits the component 10 towards the users' eye. The zones 14L, 14R, 16L and 16R are shown in FIG. 1. These mechanisms are described in detail below. FIG. 2 shows a user's eye (right or left) receiving the diffracted light from an exit zone (16L or 16R). The output beam OB to a user's eye is parallel with the incident beam IB. See, for example, the beam marked IB in FIG. 2 and two of the parallel output beams marked OB in FIG. 2. The optical component 10 is located between the light engine 13 and the eye i.e. the display system configuration is of so-called transmissive type.

Other headpieces are also within the scope of the subject matter. For instance, the display optics can equally be attached to the users head using a head band, helmet or other fit system. The purpose of the fit system is to support the display and provide stability to the display and other head borne systems such as tracking systems and cameras. The fit system will also be designed to meet user population in anthropometric range and head morphology and provide comfortable support of the display system.

Beams from the same display 15 may be coupled into both components 10L, 10R so that an image is perceived by both eyes from a single display, or separate displays may be used to generate different images for each eye e.g. to provide a stereoscopic image. In alternative headsets, light engine(s) may be mounted at one or both of left and right portions of the frame—with the arrangement of the incoupling, fold and exit zones 12, 14, 16 flipped accordingly.

The optical component 10 is substantially transparent such that a user can not only view the image from the light engine 13, but also can view a real world view through the optical component 10.

The optical component 10 has a refractive index n which is such that total internal reflection takes place guiding the beam from the incoupling zone along the intermediate expansion zone 14, and down towards the exit zone 16.

FIGS. 3A and 3B show an optical component in more detail.

FIG. 3A shows a perspective view of an optical component 10. The optical component is flat in that the front and rear portions of its surface are substantially flat (front and rear defined from the viewpoint of the wearer, as indicated by the location of the eye in FIG. 3A). The front and rear portions of the surface are parallel to one another. The optical component 10 lies substantially in a plane (xy-plane), with the z axis (referred to as the “normal”) directed towards the viewer from the optical component 10. The incoupling, fold and exit zones 12, 14 and 16 are shown, each defined by respective surface modulations 52, 46 and 56 on the surface of the optical component, which are on the rear of the waveguide from a viewpoint of the wearer. Each of the surface modulations 52, 46, 56 forms a respective surface relief grating (SRG), the nature of which will be described shortly. Instead of the SRGs, holograms could be used which provide the same optical function as the SRGs.

As shown in the plan view of FIG. 3B, the fold zone has a horizontal extent W2 (referred to herein as the “width” of the expansion zone) in the lateral (x) direction and a vertical extent H2 (referred to herein as the “height” of the expansion zone) in the y direction which increases from the inner edge of the optical component to its outer edge in the lateral direction along its width W2. The exit zone has a horizontal extent W3 (width of the exit zone) and vertical extent H3 (height of the exit zone) which define the size of the eye box, which size is independent of the imaging optics in the light engine. The incoupling and fold SRGs 52, 54 have a relative orientation angle A, as do the fold and exit SRGs 54, 56 (note the various dotted lines superimposed on the SRGs 52, 54, 56 denote directions perpendicular to the grating lines of those SRGs).

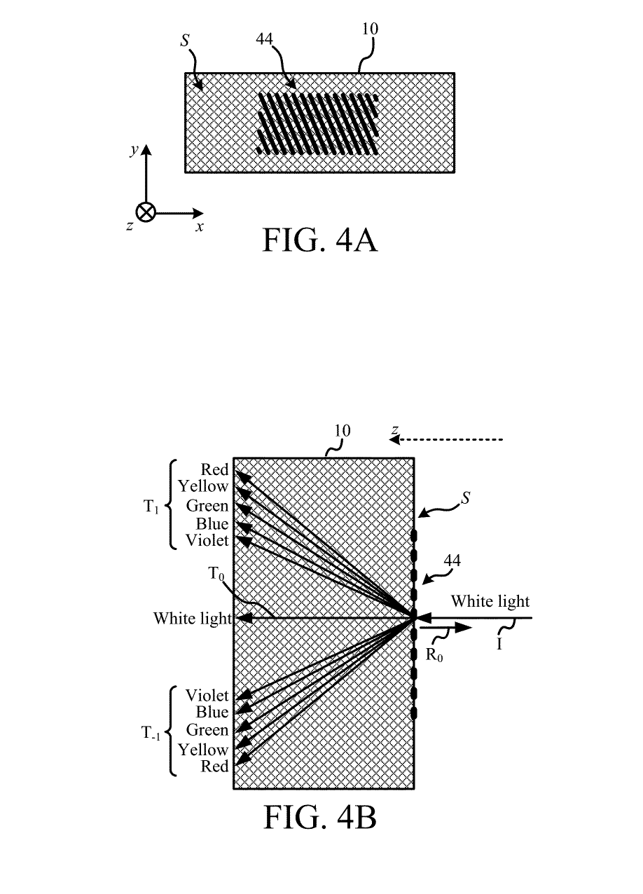

Principles of the diffraction mechanisms which underlie operation of the head mounted display described herein will now be described with reference to FIGS. 4A and 4B.

The optical components described herein interact with light by way of reflection, refractions and diffraction. Diffraction occurs when a propagating wave interacts with a structure, such as an obstacle or slit. Diffraction can be described as the interference of waves and is most pronounced when that structure is comparable in size to the wavelength of the wave. Optical diffraction of visible light is due to the wave nature of light and can be described as the interference of light waves. Visible light has wavelengths between approximately 390 and 700 nanometres (nm) and diffraction of visible light is most pronounced when propagating light encounters structures of a similar scale e.g. of order 100 or 1000 nm in scale.

One example of a diffractive structure is a periodic (substantially repeating) diffractive structure. Herein, a “diffraction grating” means any (part of) an optical component which has a periodic diffractive structure. Periodic structures can cause diffraction of light, which is typically most pronounced when the periodic structure has a spatial period of similar size to the wavelength of the light. Types of periodic structures include, for instance, surface modulations on the surface of an optical component, refractive index modulations, holograms etc. When propagating light encounters the periodic structure, diffraction causes the light to be split into multiple beams in different directions. These directions depend on the wavelength of the light thus diffractions gratings cause dispersion of polychromatic (e.g. white) light, whereby the polychromatic light is split into different coloured beams travelling in different directions.

When the periodic structure is on the surface of an optical component, it is referred to a surface grating. When the periodic structure is due to modulation of the surface itself, it is referred to as a surface relief grating (SRG). An example of a SRG is uniform straight grooves in a surface of an optical component that are separated by uniform straight groove spacing regions. Groove spacing regions are referred to herein as “lines”, “grating lines” and “filling regions”. The nature of the diffraction by a SRG depends both on the wavelength of light incident on the grating and various optical characteristics of the SRG, such as line spacing, groove depth and groove slant angle. An SRG can be fabricated by way of a suitable microfabrication process, which may involve etching of and/or deposition on a substrate to fabricate a desired periodic microstructure on the substrate to form an optical component, which may then be used as a production master such as a mould for manufacturing further optical components.

An SRG is an example of a Diffractive Optical Element (DOE). When a DOE is present on a surface (e.g. when the DOE is an SRG), the portion of that surface spanned by that DOE is referred to as a DOE area.

FIGS. 4A and 4B show from the top and the side respectively part of a substantially transparent optical component 10 having an outer surface S. At least a portion of the surface S exhibits surface modulations that constitute a SRG 44 (e.g. 52, 54, 56), which is a microstructure. Such a portion is referred to as a “grating area”. The modulations comprise grating lines which are substantially parallel and elongate (substantially longer than they are wide), and also substantially straight in this example (though they need not be straight in general).

FIG. 4B shows the optical component 10, and in particular the SRG 44, interacting with an incoming illuminating light beam I that is inwardly incident on the SRG 44. The light I is white light in this example, and thus has multiple colour components. The light I interacts with the SRG 44 which splits the light into several beams directed inwardly into the optical component 10. Some of the light I may also be reflected back from the surface S as a reflected beam R0. A zero-order mode inward beam T0 and any reflection R0 are created in accordance with the normal principles of diffraction as well as other non-zero-order (±n-order) modes (which can be explained as wave interference). FIG. 4B shows first-order inward beams T1, T−1; it will be appreciated that higher-order beams may or may not also be created depending on the configuration of the optical component 10. Because the nature of the diffraction is dependent on wavelength, for higher-order modes, different colour components (i.e. wavelength components) of the incident light I are, when present, split into beams of different colours at different angles of propagation relative to one another as illustrated in FIG. 4B.

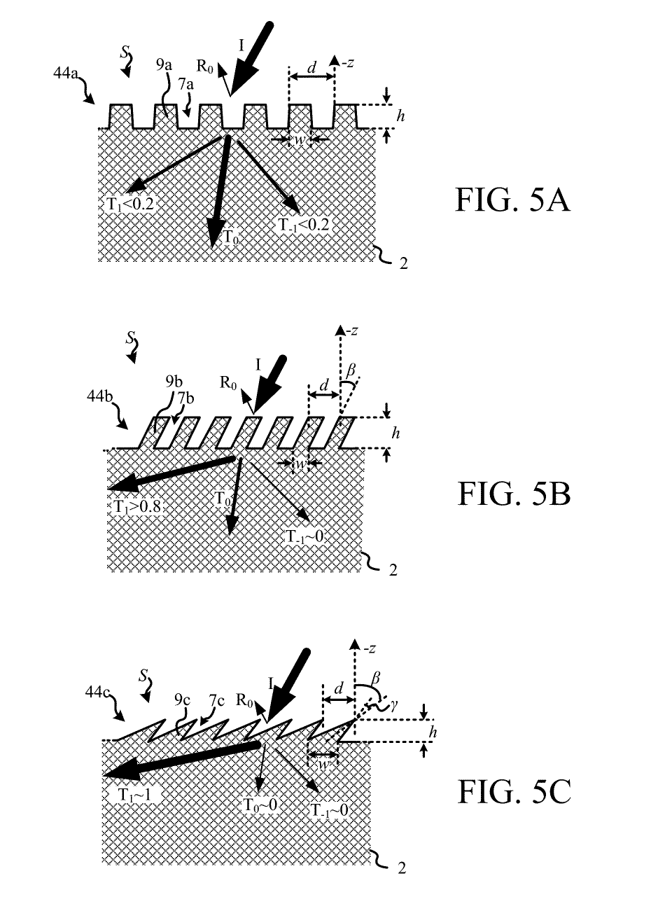

FIGS. 5A-5C are close-up schematic cross sectional views of different exemplary SRGs 44a-44c (collectively referenced as 44 herein) that may be formed by modulation of the surface S of the optical component 10 (which is viewed from the side in these figures). Light beams are denoted as arrows whose thicknesses denote approximate relative intensity (with higher intensity beams shown as thicker arrows).

FIG. 5A shows an example of a straight binary SRG 44a. The straight binary SRG 44a is formed of a series of grooves 7a in the surface S separated by protruding groove spacing regions 9a which are also referred to herein as “filling regions”, “grating lines” or simply “lines”. The SRG 44a has a spatial period of d (referred to as the “grating period”), which is the distance over which the modulations' shape repeats and which is thus the distance between adjacent lines/grooves. The grooves 7a have a depth h and have substantially straight walls and substantially flat bases. The filling regions have a height h and a width that is substantially uniform over the height h of the filling regions, labelled “w” in FIG. 2A (with w being some fraction f of the period: w=f*d).

For a straight binary SRG, the walls are substantially perpendicular to the surface S. For this reason, the SRG 44a causes symmetric diffraction of incident light I that is entering perpendicularly to the surface, in that each +n-order mode beam (e.g. T1) created by the SRG 4a has substantially the same intensity as the corresponding −n-order mode beam (e.g. T−1), typically less than about one fifth (0.2) of the intensity of the incident beam I.

FIG. 5B shows an example of a slanted binary SRG 44b. The slanted binary SRG 44b is also formed of grooves, labelled 7b, in the surface S having substantially straight walls and substantially flat bases separated by lines 9b of width w. However, in contrast to the straight SRG 44a, the walls are slanted by an amount relative to the normal, denoted by the angle β in FIG. 25B. The grooves 7b have a depth h as measured along the normal. Due to the asymmetry introduced by the non-zero slant, ±n-order mode inward beams travelling away from the slant direction have greater intensity that their ∓n-order mode counterparts (e.g. in the example of FIG. 2B, the T1 beam is directed away from the direction of slant and has usually greater intensity than the T−1 beam, though this depends on e.g. the grating period d); by increasing the slant by a sufficient amount, those ∓n counterparts can be substantially eliminated (i.e. to have substantially zero intensity). The intensity of the T0 beam is typically also very much reduced by a slanted binary SRG such that, in the example of FIG. 5B, the first-order beam T1 typically has an intensity of at most about four fifths (0.8) the intensity of the incident beam I.

The binary SRGs 44a and 44b can be viewed as spatial waveforms embedded in the surface S that have a substantially square wave shape (with period d). In the case of the SRG 44b, the shape is a skewed square wave shape skewed by β.

FIG. 5C shows an example of an overhanging triangular SRG 44c which is a special case of an overhanging trapezoidal SRG. The triangular SRG 44c is formed of grooves 7c in the surface S that are triangular in shape (and which thus have discernible tips) and which have a depth h as measured along the normal. Filling regions 9c take the form of triangular, tooth-like protrusions (teeth), having medians that make an angle β with the normal (β being the slant angle of the SRG 44c). The teeth have tips that are separated by d (which is the grating period of the SRG 44c), a width that is w at the base of the teeth and which narrows to substantially zero at the tips of the teeth. For the SRG of FIG. 44c, w≈d, but generally can be w<d. The SRG is overhanging in that the tips of the teeth extend over the tips of the grooves. It is possible to construct overhanging triangular SRGs that substantially eliminate both the transmission-mode T0 beam and the ∓n-mode beams, leaving only ±n-order mode beams (e.g. only T1). The grooves have walls which are at an angle γ to the median (wall angle).

The SRG 44c can be viewed as a spatial waveform embedded in S that has a substantially triangular wave shape, which is skewed by β.

Other SRGs are also possible, for example other types of trapezoidal SRGs (which may not narrow in width all the way to zero), sinusoidal SRGs etc. Such other SRGs also exhibit depth h, linewidth w, slant angle β and wall angles γ which can be defined in a similar manner to FIG. 5A-C.

In the present display system, d is typically between about 250 and 500 nm, and h between about 30 and 400 nm. The slant angle β is typically between about 0 and 45 degrees (such that slant direction is typically elevated above the surface S by an amount between about 45 and 90 degrees).

An SRG has a diffraction efficiency defined in terms of the intensity of desired diffracted beam(s) (e.g. T1) relative to the intensity of the illuminating beam I, and can be expressed as a ratio η of those intensities. As will be apparent from the above, slanted binary SRGs can achieve higher efficiency (e.g. 4b—up to η≈0.8 if T1 is the desired beam) than non-slanted SRGs (e.g. 44a—only up to about η≈0.2 if T1 is the desired beam). With overhanging triangular SRGs, it is possible to achieve near-optimal efficiencies of η≈1.

Returning to FIGS. 3A and 3B, it can be seen that the incoupling, fold and exit zones 12, 14, 16 are diffraction gratings whose periodic structure arises due to the modulations 52, 54, 56 of the optical component's surface that form the incoupling, fold and exit SRGs respectively, and which cover the incoupling, fold and exit zones 12, 14, 16 respectively.

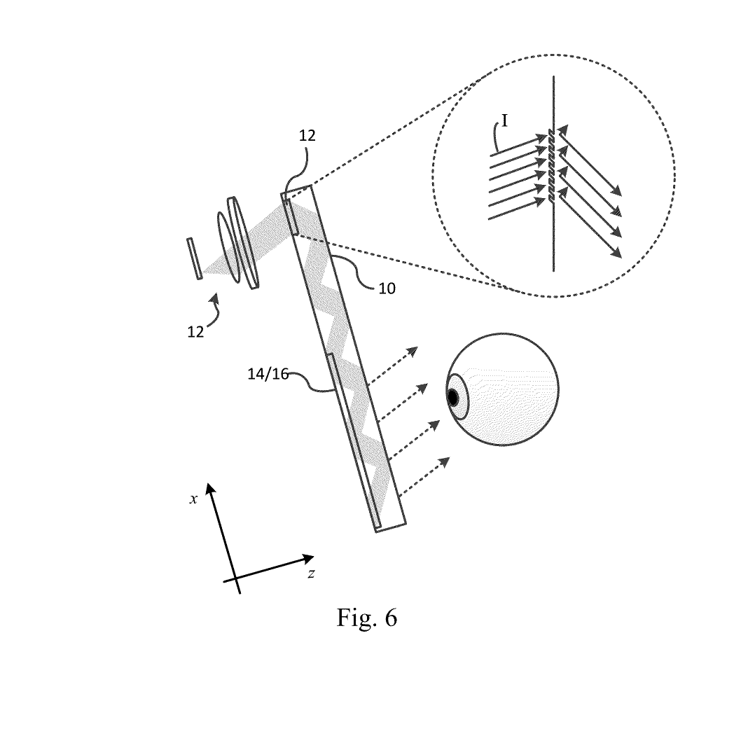

FIG. 6 shows the incoupling SRG 52 with greater clarity, including an expanded version showing how the light beam interacts with it. FIG. 6 shows a plan view of the optical component 10. The light engine 13 provides beams of collimated light, one of which is shown (corresponding to a display pixel). That beam falls on the incoupling SRG 52 and thus causes total internal reflection of the beam in the component 10. The intermediate grating 14 directs versions of the beams down to the exit grating 16, which causes diffraction of the image onto the user's eye. The operation of the grating 12 is shown in more detail in the expanded portion which shows rays of the incoming light beam coming in from the left and denoted I and those rays being diffracted so as to undergo TIR in the optical component 10. The grating in FIG. 6 is of the type shown in FIG. 5B but could also be of the type shown in FIG. 5C or some other slanted grating shape.

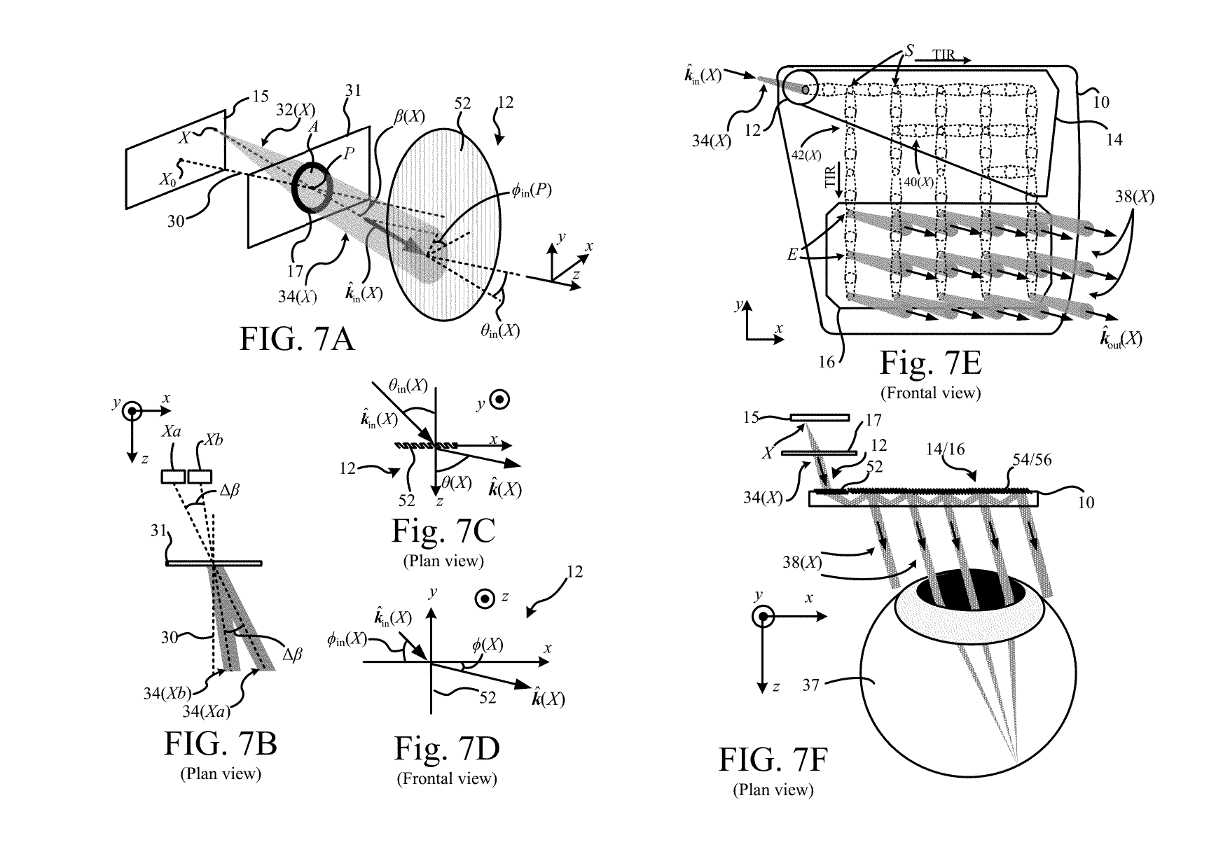

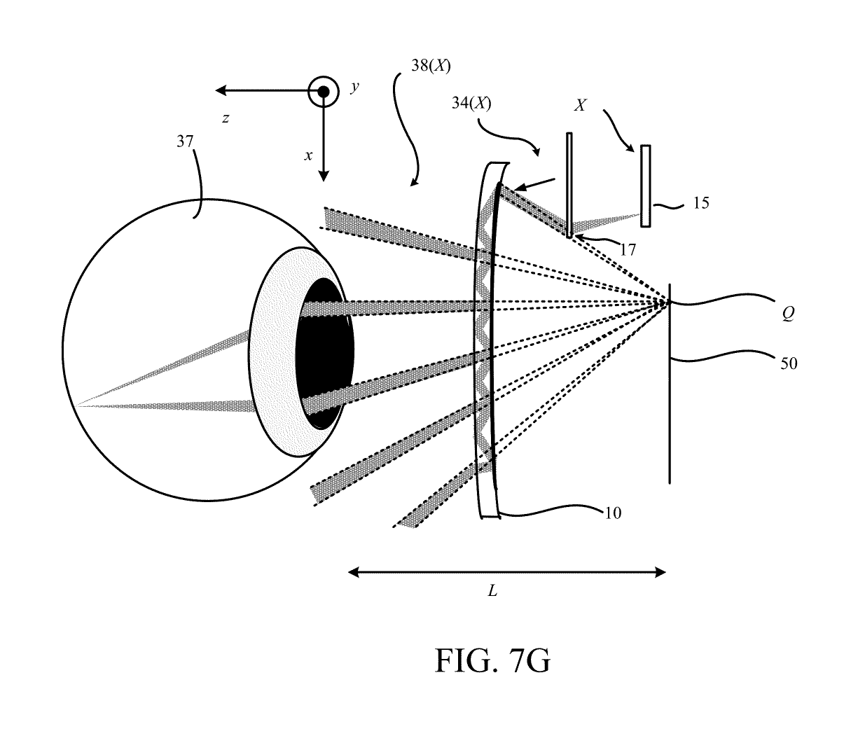

Optical principles underlying certain embodiments will now be described with reference to FIGS. 7A-9B.

FIG. 7a shows a perspective view of the display 15, imaging optics 17 and incoupling SRG 52. Different geometric points on the region of the display 15 on which an image is displayed are referred to herein as image points, which may be active (currently emitting light) or inactive (not currently emitting light). In practice, individual pixels can be approximated as image points.

The imaging optics 17 can typically be approximated as a principal plane (thin lens approximation) or, in some cases, more accurately as a pair of principal planes (thick lens approximation) the location(s) of which are determined by the nature and arrangement of its constituent lenses. In these approximations, any refraction caused by the imaging optics 17 is approximated as occurring at the principal plane(s). To avoid unnecessary complication, principles of various embodiments will be described in relation to a thin lens approximation of the imaging optics 17, and thus in relation to a single principal plane labelled 31 in FIG. 7a, but it will be apparent that more complex imaging optics that do not fit this approximation still can be utilized to achieve the desired effects.

The imaging optics 17 has an optical axis 30 and a front focal point, and is positioned relative to the optical component 10 so that the optical axis 30 intersects the incoupling SRG 52 at or near the geometric centre of the incoupling SRG 52 with the front focal point lying substantially at an image point X₀ on the display (that is, lying in the same plane as the front of the display). Another arbitrary image point X on the display is shown, and principles underlying various embodiments will now be described in relation to X without loss of generality. In the following, the terminology “for each X” or similar is used as a convenient shorthand to mean “for each image point (including X)” or similar, as will be apparent in context.

When active, image points—including the image point labelled X and X₀—act as individual illumination point sources from which light propagates in a substantially isotropic manner through the half-space forward of the display 15. Image points in areas of the image perceived as lighter emit light of higher intensity relative to areas of the image perceived as darker. Image points in areas perceived as black emit no or only very low intensity light (inactive image points). The intensity of the light emitted by a particular image point may change as the image changes, for instance when a video is displayed on the display 15.

Each active image point provides substantially uniform illumination of a collimating area A of the imaging optics 17, which is substantially circular and has a diameter D that depends on factors such as the diameters of the constituent lenses (D may be of order 1-10 mm, but this is just an example). This is illustrated for the image point X in FIG. 7a, which shows how any propagating light within a cone 32(X) from X is incident on the collimating area A. The imaging optics collimates any light 32(X) incident on the collimating area A to form a collimated beam 34(X) of diameter D (input beam), which is directed towards the incoupling grating 52 of the optical component 10. The beam 34(X) is thus incident on the incoupling grating 52. A shielding component (not shown) may be arranged to prevent any un-collimated light from outside of the cone 32(X) that is emitted from X from reaching the optical component 10.

The beam 34(X) corresponding to the image point X is directed in an inward propagation direction towards the incoupling SRG 52, which can be described by a propagation vector \hat{k}ᵢₙ(X) (herein, bold typeface is used to denote 3-dimensional vectors, with hats on such vectors indicating denoting a unit vector). The inward propagation direction depends on the location of X in the image and, moreover, is unique to X. That unique propagation direction can be parameterized in terms of an azimuthal angle φᵢₙ(X)(which is the angle between the x-axis and the projection of \hat{k}ᵢₙ(X) in the xy-plane) and a polar angle θᵢₙ(X) (which is the angle between the z-axis and \hat{k}ᵢₙ(P) as measured in the plane in which both the z-axis and \hat{k}ᵢₙ(X) lie—note this is not the xz-plane in general). The notation φᵢₙ(X), θᵢₙ(X) is adopted to denote the aforementioned dependence on X; as indicated φᵢₙ(X), θᵢₙ(X) are unique to that X. Note that, herein, both such unit vectors and such polar/azimuthal angle pairs parameterizing such vectors are sometimes referred herein to as “directions” (as the latter represent complete parameterizations thereof), and that sometimes azimuthal angles are referred to in isolation as xy-directions for the same reason. Note further that “inward” is used herein to refer to propagation that is towards the waveguide (having a positive z-component when propagation is towards the rear of the waveguide as perceived by the viewer and a negative z-component when propagation is towards the front of the waveguide).

The imaging optics has a principle point P, which is the point at which the optical axis 30 intersects the principal plane 31 and which typically lies at or near the centre of the collimation area A. The inward direction \hat{k}ᵢₙ(X) and the optical axis 30 have an angular separation β(X) equal to the angle subtended by X and X₀ from P. β(X)=θᵢₙ(X) if the optical axis is parallel to the z-axis (which is not necessarily the case).

As will be apparent, the above applies for each active image point and the imaging optics is thus arranged to substantially collimate the image which is currently on the display 15 into multiple input beams, each corresponding to and propagating in a unique direction determined by the location of a respective active image point (active pixel in practice). That is, the imaging optics 17 effectively converts each active point source X into a collimated beam in a unique inward direction \hat{k}ᵢₙ(X). As will be apparent, this can be equivalently stated as the various input beams for all the active image points forming a virtual image at infinity that corresponds to the real image that is currently on the display 17. A virtual image of this nature is sometimes referred to herein as a virtual version of the image (or similar).

The input beam corresponding to the image point X₀ (not shown) would propagate parallel to the optical axis 30, towards or near the geometric centre of the incoupling SRG 52.

As mentioned, in practice, individual pixels of the display 15 can be approximated as single image points. This is illustrated in FIG. 7B which is a schematic plan view showing the principal plane 31 and two adjacent pixels Xa, Xb of the display 15, whose centres subtend an angle Δβ from the principal point P. Light emitted the pixels Xa, Xb when active is effectively converted into collimated beams 34(Xa), 34(Xb) having an angular separation equal to Δβ. As will be apparent, the scale of the pixels Xa, Xb has been greatly enlarged for the purposes of illustration.

The beams are highly collimated, having an angular range no greater than the angle subtended by an individual pixel from P (˜Δβ) e.g. typically having an angular range no more than about ½ milliradian. As will become apparent in view of the following, this increases the image quality of the final image as perceived by the wearer.

FIGS. 7C and 7D show schematic plan (xz) and frontal (yz) views of part of the optical component respectively. As indicated in these figures, the incoupling grating 52 causes diffraction of the beam 34(X) thereby causing a first (±1) order mode beam to propagate within the optical component 10 in a new direction \hat{k}(X) that is generally towards the fold SRG 54 (i.e. that has a positive x-component). The new direction \hat{k}(X) can be parameterized by azimuthal and polar angles φ(X)—where |φ(X)|≦|φᵢₙ(X)| and θ(X)—where |O(X)|>|θᵢₙ(X)|—which are also determined by the location of and unique to the image point X. The grating 52 is configured so that the first order mode is the only significant diffraction mode, with the intensity of this new beam thus substantially matching that of the input beam. As mentioned above, a slanted grating can be used to achieve this desired effect (the beam as directed away from the incoupling SRG 52 would correspond, for instance, to beam T1 as shown in FIG. 4B or 4C). In this manner, the beam 34(X) is coupled into the incoupling zone 12 of the optical component 10 in the new direction \hat{k}(X).

The optical component has a refractive index n and is configured such that the polar angle θ(X) satisfies total internal reflection criteria given by:

sin θ(X)>1/n for each X. (1):

As will be apparent, each beam input from the imaging optics 17 thus propagates through the optical component 10 by way of total internal reflection (TIR) in a generally horizontal (+x) direction (offset from the x-axis by φ(X)<φᵢₙ(X)). In this manner, the beam 34(X) is coupled from the incoupling zone 12 into the fold zone 14, in which it propagates along the width of the fold zone 14.

FIG. 7E shows 10 a frontal (xy) view of the whole of the optical component 10, from a viewpoint similar to that of the wearer. As explained in more detail below, a combination of diffractive beam splitting and total internal reflection within the optical component 10 results in multiple versions of each input beam 34(X) being outwardly diffracted from the exit SRG along both the width and the height of the exit zone 16 as output beams 38(X) in respective outward directions (that is, away from the optical component 10) that substantially match the respective inward direction \hat{k}ᵢₙ(X) of the corresponding input beam 34(X).

In FIG. 7E, beams external to the optical component 10 are represented using shading and dotted lines are used to represent beams within the optical component 10. Perspective is used to indicate propagation in the z-direction, with widening (resp. narrowing) of the beams in FIG. 7E representing propagation in the positive (resp. negative) z direction; that is towards (resp. away from) the wearer. Thus, diverging dotted lines represent beams within the optical component 10 propagating towards the front wall of the optical component 10; the widest parts represent those beams striking the front wall of the optical component 10, from which they are totally internally reflected back towards the rear wall (on which the various SRGs are formed), which is represented by the dotted lines converging from the widest points to the narrowest points at which they are incident on the rear wall. Regions where the various beams are incident on the fold and exit SRGs are labelled S and E and termed splitting and exit regions respectively for reasons that will become apparent.

As illustrated, the input beam 34(X) is coupled into the waveguide by way of the aforementioned diffraction by the incoupling SRG 52, and propagates along the width of the incoupling zone 12 by way of TIR in the direction φ(X), ±θ(X) (the sign but not the magnitude of the polar angle changing whenever the beam is reflected). As will be apparent, this results in the beam 34(X) eventually striking the fold SRG at the left-most splitting region S.

When the beam 34(X) is incident at a splitting region S, that incident beam 34(X) is effectively split in two by way of diffraction to create a new version of that beam 42(X) (specifically a −1 reflection mode beam) which directed in a specific and generally downwards (−y) direction φ′(X), ±θ′(X) towards the exit zone 16 due to the fold SRG 54 having a particular configuration which will be described in due course, in addition to a zero order reflection mode beam (specular reflection beam), which continues to propagate along the width of the beam in the same direction φ(X), ±θ(X) just as the beam 34(X) would in the absence of the fold SRG (albeit at a reduced intensity). Thus, the beam 34(X) effectively continues propagates along substantially the whole width of the fold zone 14, striking the fold SRG at various splitting regions S, with another new version of the beam (in the same specific downward direction φ′(X), ±θ′(X)) created at each splitting region S. As shown in FIG. 7E, this results in multiple versions of the beam 34(X) being coupled into the exit zone 16, which are horizontally separated so as to collectively span substantially the width of the exit zone 16.

As also shown in FIG. 7E, a new version 42(X) of the beam as created at a splitting region S may itself strike the fold SRG during its downward propagation. This will result in a zero order mode being created which continues to propagate generally downwards in the direction φ′(X), ±θ′(X) and which can be viewed as continued propagation of that beam, but may also result in a non-zero order mode beam 40(X) (further new version) being created by way of diffraction. However, any such beam 40(X) created by way of such double diffraction at the same SRG will propagate in substantially the same direction φ(X), ±θ(X) along the width of the fold zone 14 as the original beam 34(X) as coupled into the optical component 10 (see below). Thus, notwithstanding the possibility of multiple diffractions by the fold SRG, propagation of the various versions of the beam 34(X) (corresponding to image point X) within the optical component 10 is effectively limited to two xy-directions: the generally horizontal direction (φ(X), ±θ(X)), and the specific and generally downward direction (φ′(X), ±θ′(X)) that will be discussed shortly.

Propagation within the fold zone 14 is thus highly regular, with all beam versions corresponding to a particular image point X substantially constrained to a lattice like structure in the manner illustrated.

The exit zone 16 is located below the fold zone 14 and thus the downward-propagating versions of the beam 42(X) are coupled into the exit zone 16, in which they are guided onto the various exit regions E of the output SRG. The exit SRG 56 is configured so as, when a version of the beam strikes the output SRG, that beam is diffracted to create a first order mode beam directed outwardly from the exit SRG 56 in an outward direction that substantially matches the unique inward direction in which the original beam 34(X) corresponding to image point X was inputted. Because there are multiple versions of the beam propagating downwards that are substantially span the width of the exit zone 16, multiple output beams are generated across the width of the exit zone 16 (as shown in FIG. 7E) to provide effective horizontal beam expansion.

Moreover, the exit SRG 56 is configured so that, in addition to the outwardly diffracted beams 38(X) being created at the various exit regions E from an incident beam, a zero order diffraction mode beam continuous to propagate downwards in the same specific direction as that incident beam. This, in turn, strikes the exit SRG at a lower exit zone 16s in the manner illustrated in FIG. 7E, resulting in both continuing zero-order and outward first order beams. Thus, multiple output beams 38(X) are also generated across substantially the height of the exit zone 16 to provide effective vertical beam expansion.

The output beams 38(X) are directed outwardly in outward directions that substantially match the unique input direction in which the original beam 34(X) is inputted. In this context, substantially matching means that the outward direction is related to the input direction in a manner that enables the wearer's eye to focus any combination of the output beams 38(X) to a single point on the retina, thus reconstructing the image point X (see below).

For a flat optical component (that is, whose front and rear surfaces lie substantially parallel to the xy-plane in their entirety), the output beams are substantially parallel to one another (to at least within the angle Δβ subtended by two adjacent display pixels) and propagate outwardly in an output propagation direction \hat{k}ₒᵤₜ(X) that is parallel to the unique inward direction \hat{k}ᵢₙ(X) in which the corresponding input beam 34(X) was directed to the incoupling SRG 52. That is, directing the beam 34(X) corresponding to the image point X to the incoupling SRG 52 in the inward direction \hat{k}ᵢₙ(X) causes corresponding output beams 38(X) to be diffracted outwardly and in parallel from the exit zone 16, each in an outward propagation direction \hat{k}ₒᵤₜ(X)=\hat{k}ᵢₙ(X) due to the configuration of the various SRGs (see below).

As will now be described with reference to FIG. 7F, this enables a viewer's eye to reconstruct the image when looking at the exit zone 16. FIG. 7F shows a plan (xz) view of the optical component 10. The input beam 34(X) is in coupled to the optical component 10 resulting in multiple parallel output beams 38(X) being created at the various exit regions E in the manner discussed above. This can be equivalently expressed at the various output beams corresponding to all the image points forming the same virtual image (at infinity) as the corresponding input beams.

Because the beams 38(X) corresponding to the image point X are all substantially parallel, any light of one or more of the beam(s) 38(X) which is received by the eye 37 is focussed as if the eye 37 were perceiving an image at infinity (i.e. a distant image). The eye 37 thus focuses such received light onto a single retina point, just as if the light were being received from the imaging optics 17 directly, thus reconstructing the image point X (e.g. pixel) ion the retina. As will be apparent, the same is true of each active image point (e.g. pixel) so that the eye 37 reconstructs the whole image that is currently on the display 15.

However, in contrast to receiving the image directly from the optics 17—from which only a respective single beam 34(X) of diameter D is emitted for each X—the output beams 39(X) are emitted over a significantly wider area i.e. substantially that of the exit zone 16, which is substantially larger than the area of the inputted beam (˜D²). It does not matter which (parts) of the beam(s) 38(X) the eye receives as all are focused to the same retina point—e.g., were the eye 37 to be moved horizontally (±x) in FIG. 7F, it is apparent that the image will still be perceived. Thus, no adaptation of the display system is required for, say, viewers with different pupillary distances beyond making the exit zone 16 wide enough to anticipate a reasonable range of pupillary distances: whilst viewers whose eyes are closer together will generally receive light from the side of the exit zone 16 nearer the incoupling zone 12 as compared with viewers whose eyes are further apart, both will nonetheless perceive the same image. Moreover, as the eye 27 rotates, different parts of the image are brought towards the centre of the viewer's field of vision (as the angle of the beams relative to the optical axis of the eye changes) with the image still remaining visible, thereby allowing the viewer to focus their attention on different parts of the image as desired.

The same relative angular separation Δβ exhibited the input beams corresponding any two adjacent pixels Xa, Xb is also exhibited by the corresponding sets of output beams 38(Xa), 38(Xb)—thus adjacent pixels are focused to adjacent retina points by the eye 37. All the various versions of the beam remain highly collimated as they propagate through the optical component 10, preventing significant overlap of pixel images as focused on the retina, thereby preserving image sharpness.

It should be noted that FIGS. 7A-7G are not to scale and that in particular beams diameters are, for the sake of clarity, generally reduced relative to components such as the display 15 than would typically be expected in practice.

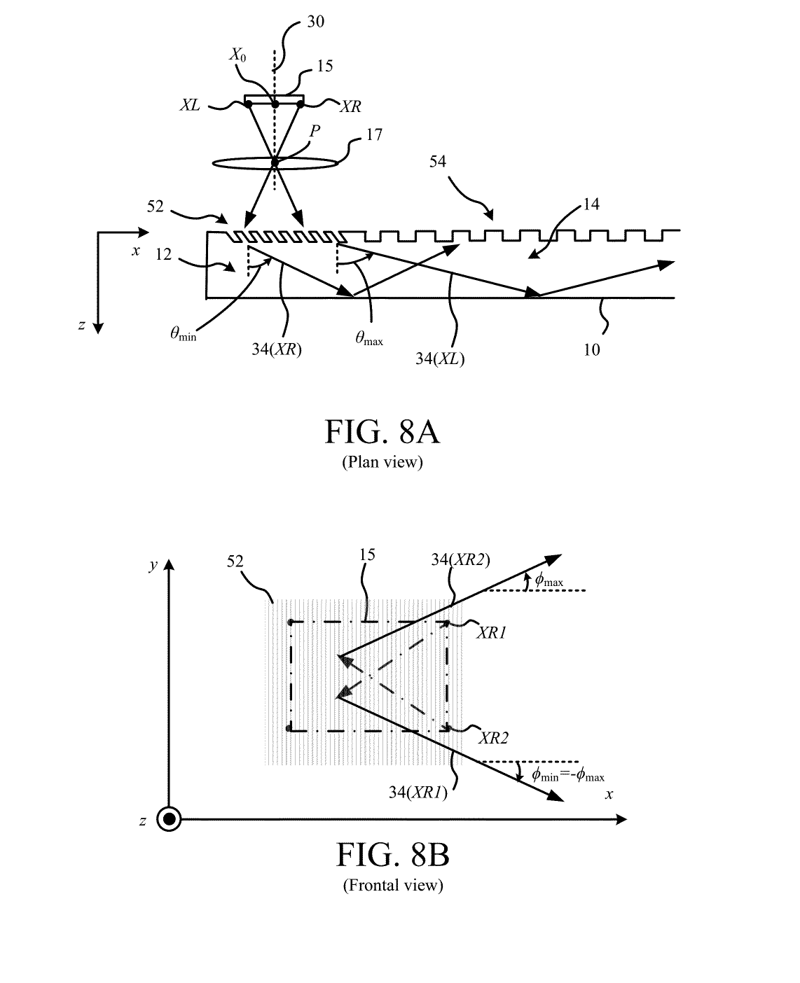

The configuration of the incoupling SRG 52 will now be described with reference to FIGS. 8A and 8B, which show schematic plan and frontal views of part of the fold grating 52. Note, in FIGS. 8A and 8B, beams are represented by arrows (that is, their area is not represented) for the sake of clarity.

FIG. 8A shows two image points XL, XR located at the far left and far right of the display 15 respectively, from which light is collimated by the optics 17 to generate respective input beams 34(XL), 34(XR) in inward directions (θᵢₙ(XL), φᵢₙ(XL)), (θᵢₙ(XR), φᵢₙ(XR)). These beams are coupled into the optical component 10 by the incoupling SRG 52 as shown—the incoupled beams shown created at the incoupling SRG 52 are first order (+1) mode beams created by way of diffraction of the beams incident on the SRG 52. The beams 34(XL), 34(XR) as coupled into the waveguide propagate in directions defined by the polar angles θ(XL), θ(XR).

FIG. 8B shows two image points XR1 and XR2 at the far top-right and far bottom-right of the display 15. Note in this figure dashed-dotted lines denote aspects which are behind the optical component 10 (−z). Corresponding beams 34(XL), 34(XR) in directions within the optical component 10 with polar angles φ(XL), φ(XR).

Such angles θ(X), φ(X) are given by the (transmissive) grating equations:

$$\begin{matrix}n sin θ ( X ) sin φ ( X ) = sin {θ}_{in} ( X ) sin {φ}_{in} ( X ) & ( 2 ) \\ n sin θ ( X ) cos φ ( X ) = sin {θ}_{in} ( X ) cos {φ}_{in} ( X ) + \frac{λ}{{d}_{1}} & ( 3 )\end{matrix}$$

with the SRG 52 having a grating period d₁, the beam light having a wavelength Δ, and n the refractive index of the optical component.

It is straightforward to show from (2), (3) that θ(XL)=θₘₐₓ and θ(XR)=θₘᵢₙ i.e. that any beam as coupled into the component 10 propagates with an initial polar angle in the range [θ(XR), θ(XL)]; and that φ(XR2)=φₘₐₓ and φ(XR1)=φₘᵢₙ (≈−φₘₐₓ in this example) i.e. that any beam as coupled into the component initially propagates with an azimuthal angle in the range [φ(XR1), φ(XR2)] (≈[−φ(XR2), φ(XR2)]).

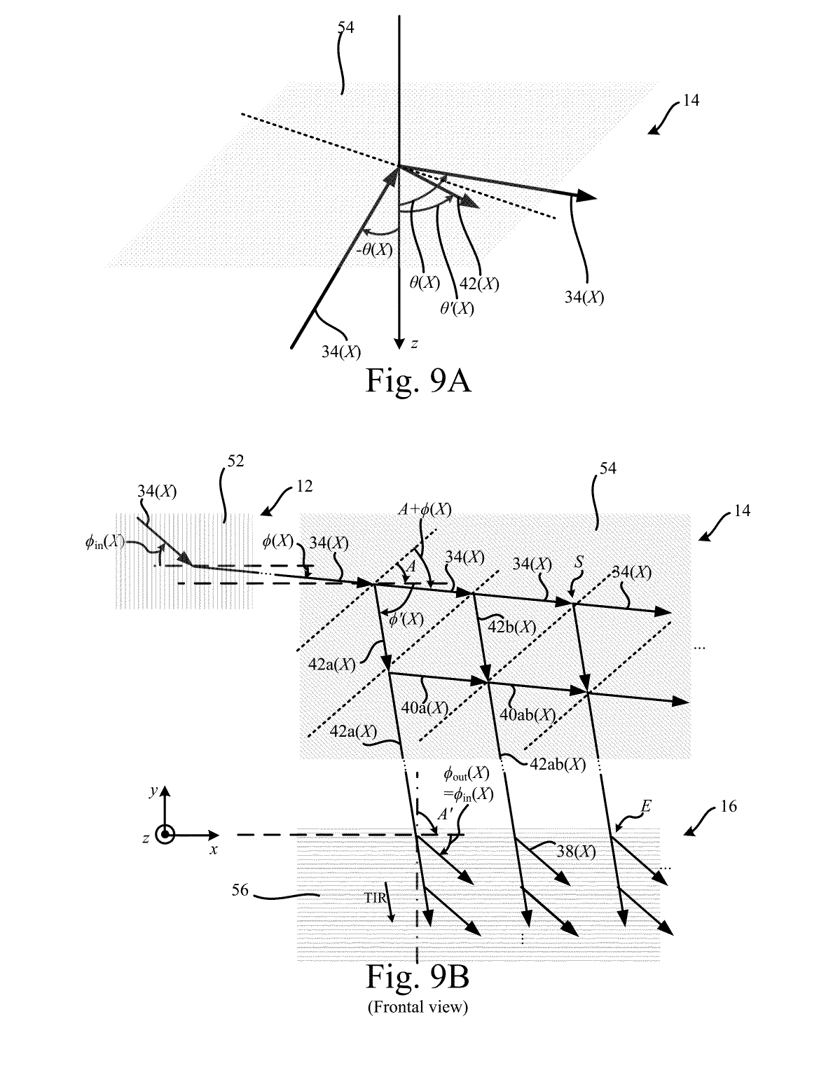

The configuration of the fold SRG 54 will now be described with references to FIGS. 9A-9B. Note, in FIGS. 9A and 9B, beams are again represented by arrows, without any representation of their areas, for the sake of clarity. In these figures, dotted lines denote orientations perpendicular to the fold SRG grating lines, dashed lines orientations perpendicular to the incoupling SRG grating lines, and dash-dotted lines orientations perpendicular to the exit SRG grating lines.

FIG. 9A shows a perspective view of the beam 34(X) as coupled into the fold zone 14 of the optical component 10, having been reflected from the front wall of the optical component 10 and thus travelling in the direction (φ(X), −θ(X)) towards the fold SRG 54. A dotted line (which lies perpendicular to the fold SRG grating lines) is shown to represent the orientation of the fold SRG.

The fold SRG 54 and incoupling SRG 52 have a relative orientation angle A (which is the angle between their respective grating lines). The beam thus makes an angle A+φ(X) (see FIG. 9B) with the fold SRG grating lines as measured in the xy-plane. The beam 34 is incident on the fold SRG 54, which diffracts the beam 34 into different components. A zero order reflection mode (specular reflection) beam is created which continues to propagate in the direction (φ(X), +θ(X)) just as the beam 34(X) would due to reflection in the absence of the fold SRG 54 (albeit at a reduced intensity). This specular reflection beam can be viewed as effectively a continuation of the beam 34(X) and for this reason is also labelled 34(X). A first order (−1) reflection mode beam 42(X) is also created which can be effectively considered a new version of the beam.

As indicated, the new version of the beam 42(X) propagates in a specific direction (φ′(X), θ′(X)) which is given by the known (reflective) grating equations:

$$\begin{matrix}n sin {θ}^{′} ( X ) sin ( A + {φ}^{′} ( X ) ) = n sin θ ( X ) sin ( A + φ ( X ) ) & ( 4 ) \\ n sin {θ}^{′} ( X ) cos ( A + {φ}^{′} ( X ) ) = n sin θ ( X ) cos ( A + φ ( X ) ) - \frac{λ}{{d}_{2}} & ( 5 )\end{matrix}$$

where the fold SRG has a grating period d₂, the beam light has a wavelength Δ and n is the refractive index of the optical component 10.

As shown in FIG. 9B, which shows a schematic frontal view of the optical component 10, the beam 34(X) is coupled into the incoupling zone 12 with azimuthal angle φ(X) and thus makes an xy-angle φ(X)+A the fold SRG 54.

A first new version 42a(X) (−1 mode) of the beam 34(X) is created when it is first diffracted by the fold SRG 54 and a second new version 42b(X) (−1 mode) when it is next diffracted by the fold SRG 54 (and so on), which both propagate in xy-direction φ′(X). In this manner, the beam 34(X) is effectively split into multiple versions, which are horizontally separated (across the width of the fold zone 14). These are directed down towards the exit zone 16 and thus coupled into the exit zone 16 (across substantially the width of the exit zone 16 due to the horizontal separation). As can be see, the multiple versions are thus incident on the various exit regions (labelled E) of the exit SRG 56, which lie along the width of the exit zone 16.

These new, downward (−y)-propagating versions may themselves meet the fold SRG once again, as illustrated. However, it can be shown from (4), (5) that any first order reflection mode beam (e.g. 40a(X), +1 mode) created by diffraction at an SRG of an incident beam (e.g. 42a(X), −1 mode) which is itself a first order reflection mode beam created by an earlier diffraction of an original beam (e.g. 34(X)) at the same SRG will revert to the direction of the original beam (e.g. φ(X), ±θ(X), which is the direction of propagation of 40a(X)). Thus, propagation within the fold zone 14 is restricted to a diamond-like lattice, as can be seen from the geometry of FIG. 9B. The beam labelled 42ab(X) is a superposition of a specular reflection beam created when 42b(X) meets the fold SRG 54 and a −1 mode beam created when 40a(X) meets the fold SRG at substantially the same location; the beam labelled 42ab(X) is a superposition of a specular reflection beam created when 40a(X) meets the fold SRG 54 and a +1 mode beam created when 42b(X) meets the fold SRG at substantially the same location (and so on).

The exit SRG and incoupling SRG 52, 56 are oriented with a relative orientation angle A′ (which is the angle between their respective grating lines). At each of the exit regions, the version meeting that region is diffracted so that, in addition to a zero order reflection mode beam propagating downwards in the direction φ′(X), ±θ′(X), a first order (+1) transmission mode beam 38(X) which propagates away from the optical component 10 in an outward direction φₒᵤₜ(X), θₒᵤₜ(X) given by:

$$\begin{matrix}sin {θ}_{out} ( X ) sin ( {A}^{′} + {φ}_{out} ( X ) ) = n sin {θ}^{′} ( X ) sin ( {A}^{′} + {φ}^{′} ( X ) ) & ( 6 ) \\ sin {θ}_{out} ( X ) cos ( {A}^{′} + {φ}_{out} ( X ) ) = n sin {θ}^{′} ( X ) cos ( {A}^{′} + {φ}^{′} ( X ) ) + \frac{λ}{{d}_{3}} & ( 7 )\end{matrix}$$

The output direction θₒᵤₜ(X), φₒᵤₜ(X) is that of the output beams outside of the waveguide (propagating in air). For a flat waveguide, equations (6), (7) hold both when the exit grating is on the front of the waveguide—in which case the output beams are first order transmission mode beams (as can be seen, equations (6), (7) correspond to the known transmission grating equations)—but also when the exit grating is on the rear of the waveguide (as in FIG. 7F)—in which case the output beams correspond to first order reflection mode beams which, upon initial reflection from the rear exit grating propagate in a direction θₒᵤₜ′(X), φₒᵤₜ′(X) within the optical component 10 given by:

$$\begin{matrix}n sin {θ}_{out}^{′} ( X ) sin ( {A}^{′} + {φ}_{out}^{′} ( X ) ) = n sin {θ}^{′} ( X ) sin ( {A}^{′} + {φ}^{′} ( X ) ) & ( {6}^{′} ) \\ n sin {θ}_{out}^{′} ( X ) cos ( {A}^{′} + {φ}_{out}^{′} ( X ) ) = n sin {θ}^{′} ( X ) cos ( {A}^{′} + {φ}^{′} ( X ) ) + \frac{λ}{{d}_{3}} ; & ( {7}^{′} )\end{matrix}$$

these beams are then refracted at the front surface of the optical component, and thus exit the optical component in a direction θᵢₙ(X), φᵢₙ(X) given by Snell's law:

sin θₒᵤₜ(X)=n sin θ′ₒᵤₜ(X) (8)

φ′ₒᵤₜ(X)=φₒᵤₜ(X) (9)

As will be apparent, the conditions of equations (6), (7) follow straight forwardly from (6′), (7′), (8) and (9). Note that such refraction at the front surface, whilst not readily visible in FIG. 7F, will nonetheless occur in the arrangement of FIG. 7F.
It can be shown from the equations (2-7) that, when

d=d₁=d₃ (10)

(that is, when the periods of the incoupling and exit SRGs 52, 56 substantially match);

d₂=d/(2 cos A); (11)

and

A′=2A; (12)

then (θₒᵤₜ(X), φₒᵤₜ(X))=(θᵢₙ(X), φᵢₙ(X)).
Moreover, when the condition

$$\sqrt{( 1 + 8 {cos}^{2} A )} {>}_{\cdot } \frac{nd}{λ} \qquad ( 13 )$$

is met, no modes besides the above-mentioned first order and zero order reflection modes are created by diffraction at the fold SRG 54. That is, no additional undesired beams are created in the fold zone when this criteria is met. The condition (13) is met for a large range of A, from about 0 to 70 degrees.

In other words, when these criteria are met, the exit SRG 56 effectively acts as an inverse to the incoupling SRG 52, reversing the effect of the incoupling SRG diffraction for each version of the beam with which it interacts, thereby outputting what is effectively a two-dimensionally expanded version of that beam 34(X) having an area substantially that of the exit SRG 56 (>>D² and which, as noted, is independent of the imaging optics 17) in the same direction as the original beam was inputted to the component 10 so that the outwardly diffracted beams form substantially the same virtual image as the inwardly inputted beams but which is perceivable over a much larger area.

In the example of FIG. 9B, A≈45° i.e. so that the fold SRG and exit SRGs 54, 56 are oriented at substantially 45 and 90 degrees to the incoupling SRG 52 respectively, with the grating period of the fold region d₂=d/\sqrt{2}. However, this is only an example and, in fact, the overall efficiency of the display system is typically increased when A≧50°.

The above considers flat optical components, but a suitably curved optical component (that is, having a radius of curvature extending substantially along the z direction) can be configured to function as an effective lens such that the output beams 30(X) are and are no longer as highly collimated and are not parallel, but have specific relative direction and angular separations such that each traces back to a common point of convergence—this is illustrated in FIG. 7G, in which the common point of convergence is labelled Q. Moreover, when every image point is considered, the various points of convergence for all the different active image points lie in substantially the same plane, labelled 50, located a distance L from the eye 37 so that the eye 37 can focus accordingly to perceive the whole image as if it were the distance L away. This can be equivalently stated as the various output beams forming substantially the same virtual version of the current display image as the corresponding input beams, but at the distance L from the eye 37 rather than at infinity. Curved optical components may be particularly suitable for short-sighted eyes unable to properly focus distant images.

Note, in general the “width” of the fold and exit zones does not have to be their horizontal extent—in general, the width of a fold or exit zone 14, 16 is that zone's extent in the general direction in which light is coupled into the fold zone 14 from the incoupling zone 12 (which is horizontal in the above examples, but more generally is a direction substantially perpendicular to the grating lines of the incoupling zone 12).

Note that the above arrangement of the light engine 13 is just an example. For example, an alternative light engine based on so-called scanning can provide a single beam, the orientation of which is fast modulated whilst simultaneously modulating its intensity and/or colour. As will be apparent, a virtual image can be simulated in this manner that is equivalent to a virtual image that would be created by collimating light of a (real) image on a display with collimating optics.

Making an optical component which includes SRGs typically involves the use of microfabrication techniques.

Microfabrication refers to the fabrication of desired structures of micrometre scales and smaller. Microfabrication may involve etching of and/or deposition on a substrate, to create the desired microstructure on the substrate.

Wet etching involves using a liquid etchant to selectively dislodge parts of a substrate e.g. parts of a film deposited on a surface of a plate and/or parts of the surface of the plate itself. The etchant reacts chemically with the substrate e.g. plate/film to remove parts of the substrate e.g. plate/film that are exposed to the etchant. The selective etching may be achieved by depositing a suitable protective layer on the substrate/film that exposes only parts of the substrate e.g. plate/film to the chemical effects of etchant and protects the remaining parts from the chemical effects of the etchant. The protective layer may be formed of a photoresist or other protective mask layer.

Dry etching involves selectively exposing a substrate e.g. plate/film (e.g. using a similar photoresist mask) to a bombardment of energetic particles to dislodge parts of the substrate e.g. plate/film that are exposed to the particles (sometimes referred to as “sputtering”). An example is ion beam etching in which parts are exposed to a beam of ions. Those exposed parts may be dislodged as a result of the ions chemically reacting with those parts to dislodge them (sometimes referred to as “chemical sputtering”) and/or physically dislodging those parts due to their kinetic energy (sometimes referred to as “physical sputtering”).

In contrast to etching, deposition—such as ion-beam deposition or immersion-based deposition—involves applying material to rather than removing material from a substrate e.g. plate/film. As used herein, the term “patterning a substrate's surface” or similar encompasses all such etching of/deposition on a plate or film, and such etching of/deposition on a plate or film is said to impose structure on the substrate's surface.

Conventional techniques for making an optical component involve, for instance, first coating a to-be patterned region of a master plate's surface (desired surface region) in a chromium layer or other protective mask layer (e.g. another metallic layer). The master plate and film constitute a substrate. The mask layer is covered in a positive photoresist. Positive photoresist means photoresist which becomes developable when exposed to light i.e. photoresist which has a composition such that those parts which have been exposed to light (and only those parts) are soluble in a developing fluid used to develop the photoresist following exposure. Light which forms a desired grating pattern (grating structure)—created, for instance, using two-beam laser interference to generate light which forms a grating structure in the form of an interference pattern—is then projected onto the photoresist so that only the photoresist at the locations of the light bands is exposed. The photoresist is then developed to remove the exposed parts, leaving selective parts of the mask layer visible (i.e. revealing only selective parts) and the remaining parts covered by the unexposed photoresist at the locations of the dark fringes. The uncovered parts of the mask layer are then be removed using conventional etching techniques e.g. an initial wet etching or ion beam etching process which removes the uncovered parts of the mask but not the parts covered by the photoresist, and which does not substantially affect the plate itself. Etching of the plate itself—such as further wet etching or further ion beam etching—is then performed, to transfer the pattern from the etched mask layer to the substrate itself.

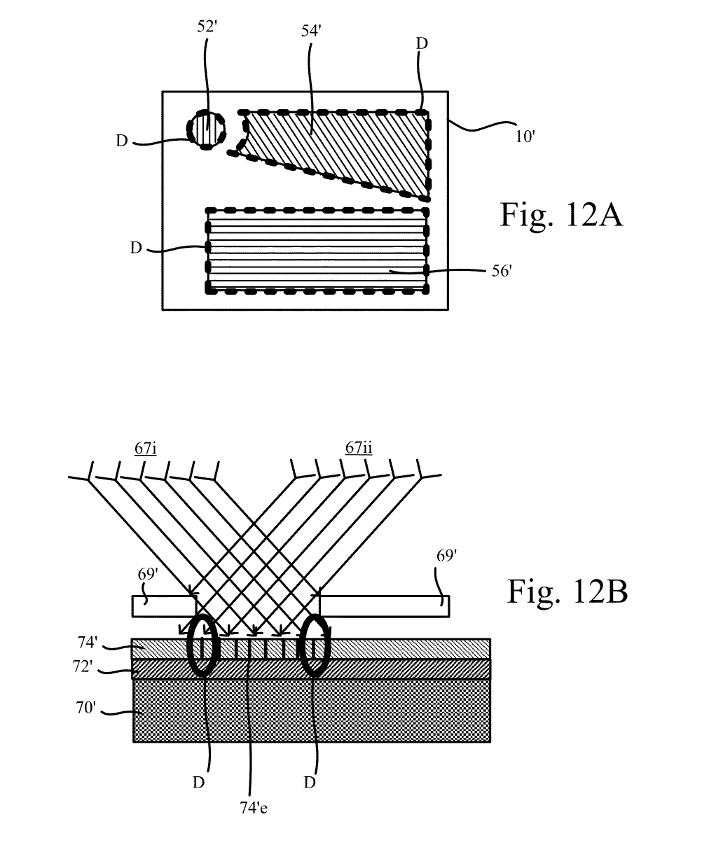

FIG. 12A shows another optical component 10′ which is similar in some respects to the optical component 10 of FIGS. 3A and 3B, but with some important differences that will now be discussed. As illustrated, the other optical component 10′ has SRGs 52′ (incoupling), 54′ (fold), 56′ (exit) similar to those of the optical component 10, with large gaps (>>100 μm) between them, including between the incoupling and fold SRGs 52′, 54′. Because of this large spacing, in manufacturing the other optical component 10′, the laser interference exposure could be done, using a positive photoresist technique along the lines of that outlined above, simply by applying shadow masks of different shapes in front of a master plate (substrate) during laser interference exposure.

This is illustrated in FIG. 12B, which shows a master plate 70′ from the side during a two-beam laser interference exposure process. The plate 70′ is coated in a chromium layer 72′, which is itself coated in photoresist 74′, which is positive photoresist. The plate 70′ and film 72′ constitute a substrate. An interference pattern is created by the interference of two laser beams 67i, 67ii. A shadow mask 69′ is used to prevent the pattern from falling outside of a desired portion (e.g. that spanned by incoupling SRG 52′) of the substrate's surface so that the only photoresist which is exposed is the parts covering the desired portion on which light bands of the interference pattern fall (exposed photoresist is shown in black and labelled 74′e in FIG. 12B). This can then be repeated for any other portions to be patterned (e.g. for those spanned by 54′ and 56′). The positive photoresist can then be developed to remove the exposed parts 74′e, and the substrate patterned in the manner outlined above.

The shadow mask, however, causes distortion near the edges of the DOE areas. The distortion is due to light scattering, non-perfect contact of shadow mask and the finite thickness of the shadow mask (which effectively blurs the pattern near its edge). Herein, non-uniformity of a grating structure exhibited near its edges (of the type caused by such shadowing during fabrication, or similar) is referred to as “edge distortion”. Edge distortion is indicated by the label D in FIG. 12B.

When the photoresist is developed, the edge distortion becomes embodied in the developed photoresist along with the grating structure, and as a result is transferred to the surface of the plate 70′ when it comes to etching. As a result, the final optical component 10′ (which either comprises or is manufactured from the patterned plate) also exhibits corresponding edge distortion as indicated by the dotted lines labelled D around the edges of the various DOE areas in FIG. 12A.

Moreover, as well as creating edge distortion, it is difficult to position the shadow mask 69′ accurately when exposing the substrate in this manner, and therefore it would be difficult to reduce the size of the gaps between the SRGs 52′, 54′ without risking overlap between the SRGs 52′, 54′.

Returning to FIG. 3B, in contrast to the other optical component 10′ of FIG. 12A, the incoupling and fold zones 12, 14 of the optical component 10 are substantially contiguous in that they are separated by at most a narrow border zone 18 which has a width W as measured along (that is, perpendicular to) a common border 19 that divides the border zone 18. That is, the incoupling and fold zones are separated by a small distance W in width along a common border 18. Moreover, the incoupling, fold and exit SRGs 52,54, 56 of the optical component 10 are free from edge distortion of the kind described above. It has been observed that this configuration produces superior image quality to that of the other optical component 10′.

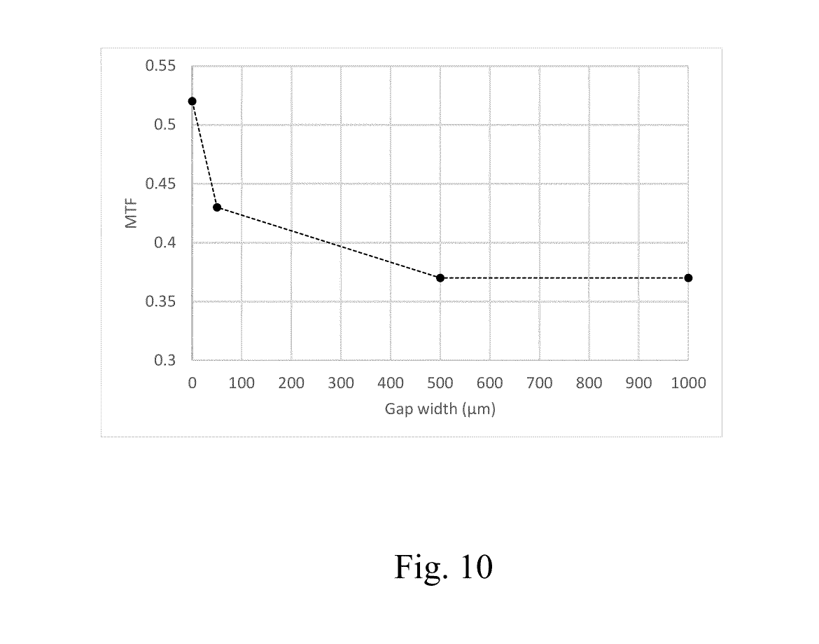

In particular, it has been observed that, when the separation W of the incoupling and fold regions 12, 14 along the common border 19 (the gap) is reduced to W≦Wₘₐₓ along the length of the common border 19 (that is, provided the incoupling and fold zones are separated by no more than Wₘₐₓ in width along the length of the common border 19)—where Wₘₐₓ≈100 μm (micrometres)—an improvement in image quality can be obtained. In practice, the size of gap at which the improvement is observed may have some dependence on the thickness of the waveguide. For example, for a waveguide having a thickness (extent in the z direction, as it is shown in the figures) of approximately 0.6 mm or less, a dramatic improvement in image quality is observed when Wₘₐₓ is approximately 50 μm or less. This particular case is illustrated in FIG. 10, which shows curve of MTF (modular transfer function) drop as function of gap width in one case included for FIG. 10. The increase in MTF as the gap is reduced from 50 μm is immediately evident in FIG. 10. As is well known to persons skilled in the art, the modular transfer function (MTF) is a measure of the ability of an optical system to transfer various levels of detail from object to image. An MTF of 1.0 (or 100%) represents perfect contrast preservation, whereas values less than this mean that more and more contrast is being lost—until an MTF of 0 (or 0%), where line pairs (a line pair is a sequence of one black line and one white line) can no longer be distinguished at all. For a thicker waveguide—e.g. of thickness approximately 1 mm, an improvement is still expected for a gap size of up to 100 μm.

The common border 19 of FIG. 3B is arcuate (substantially semi-circular in this example), with the incoupling and fold regions 12, 14 having edges which are arcuate (in this case, substantially semi-circular) along the common border 19. The edge of incoupling region 12 is substantially circular overall.

The disclosure recognizes that conventional microfabrication techniques are ill suited to making the optical component 10 of FIG. 3B. In particular, existing techniques are ill-suited to making optical components exhibiting the requisite incoupling-fold zone separation W≦Wₘₐₓ and which are free of edge distortion whilst still accurately maintaining the desired angular orientation relationship between the various SRGs 52, 54, and 56 described above with reference to FIG. 9B.

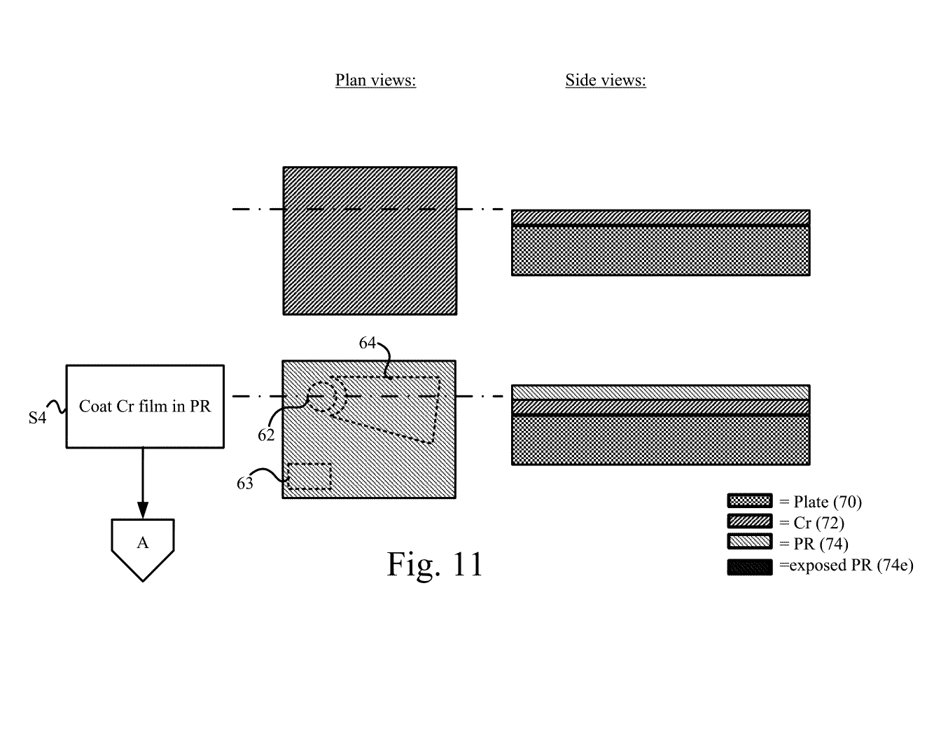

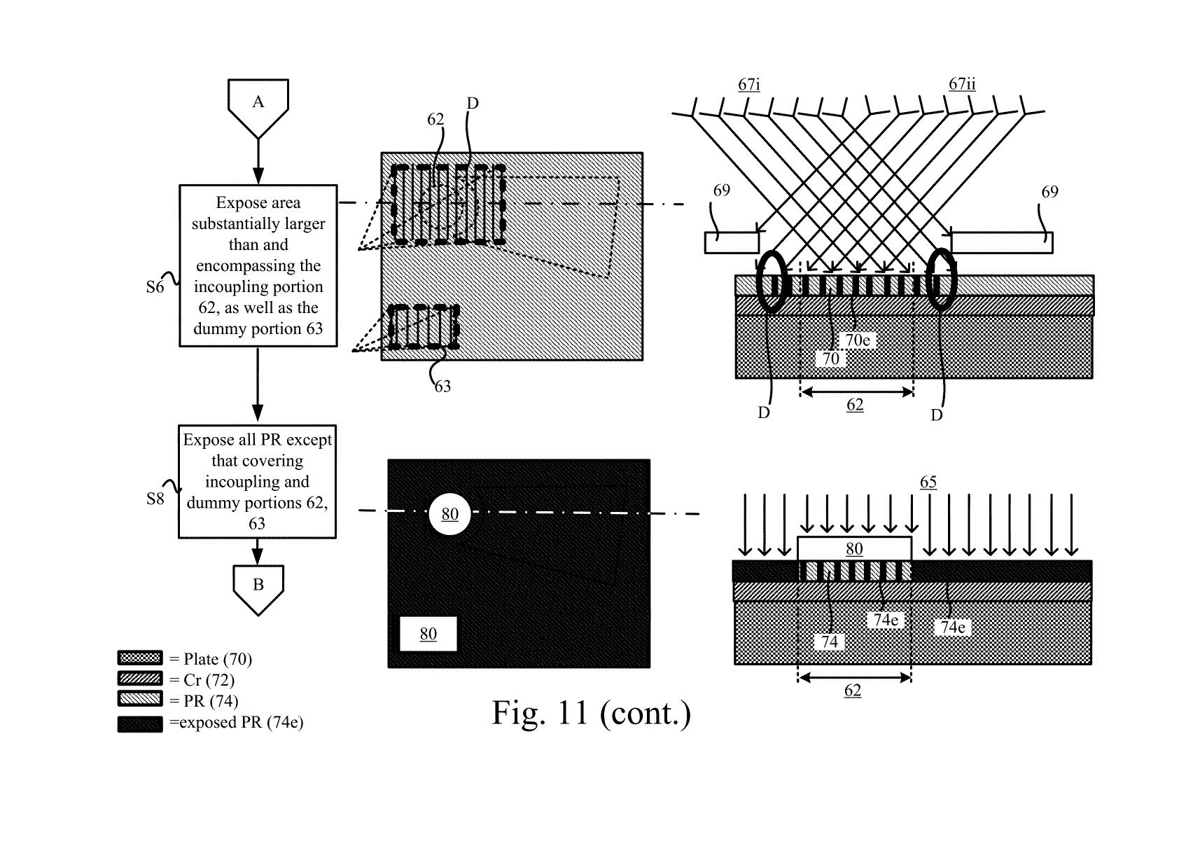

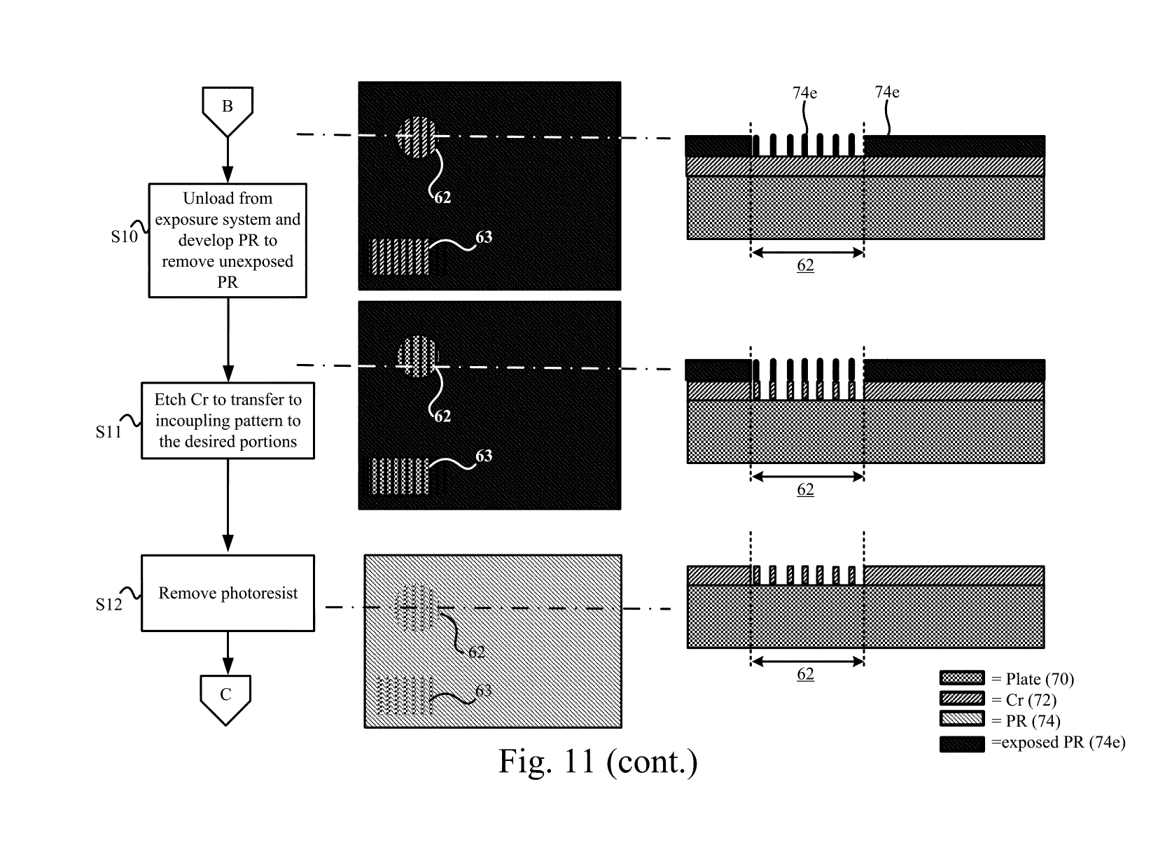

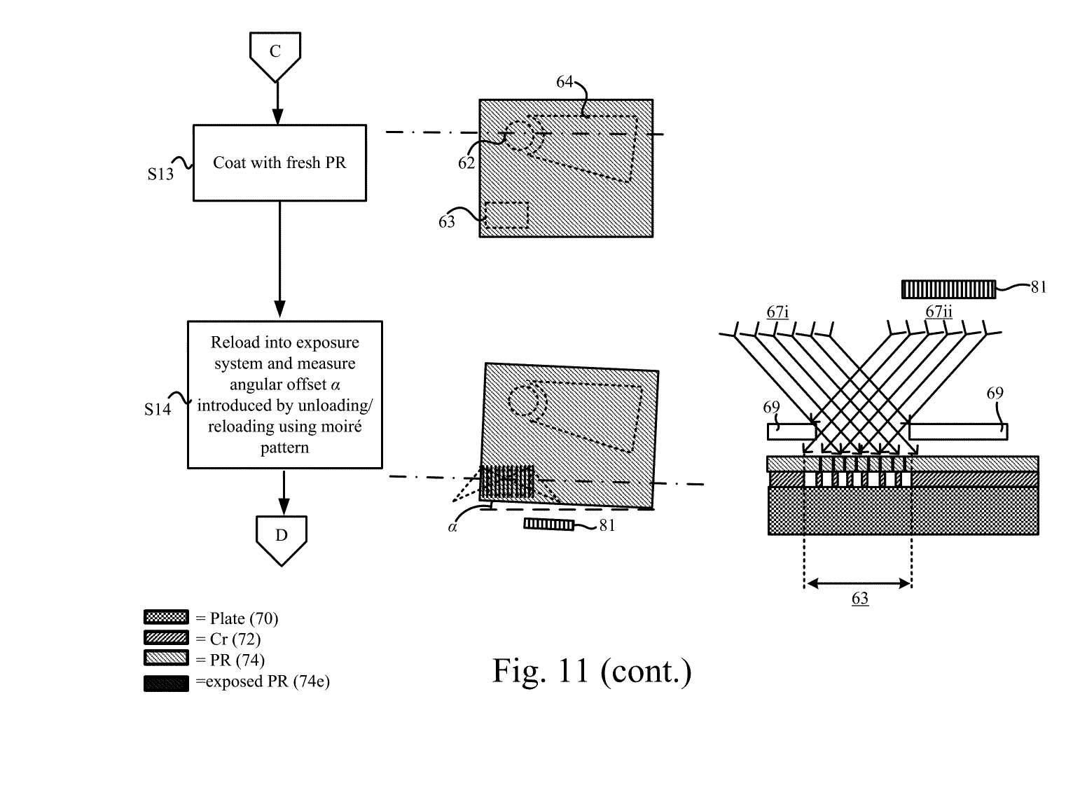

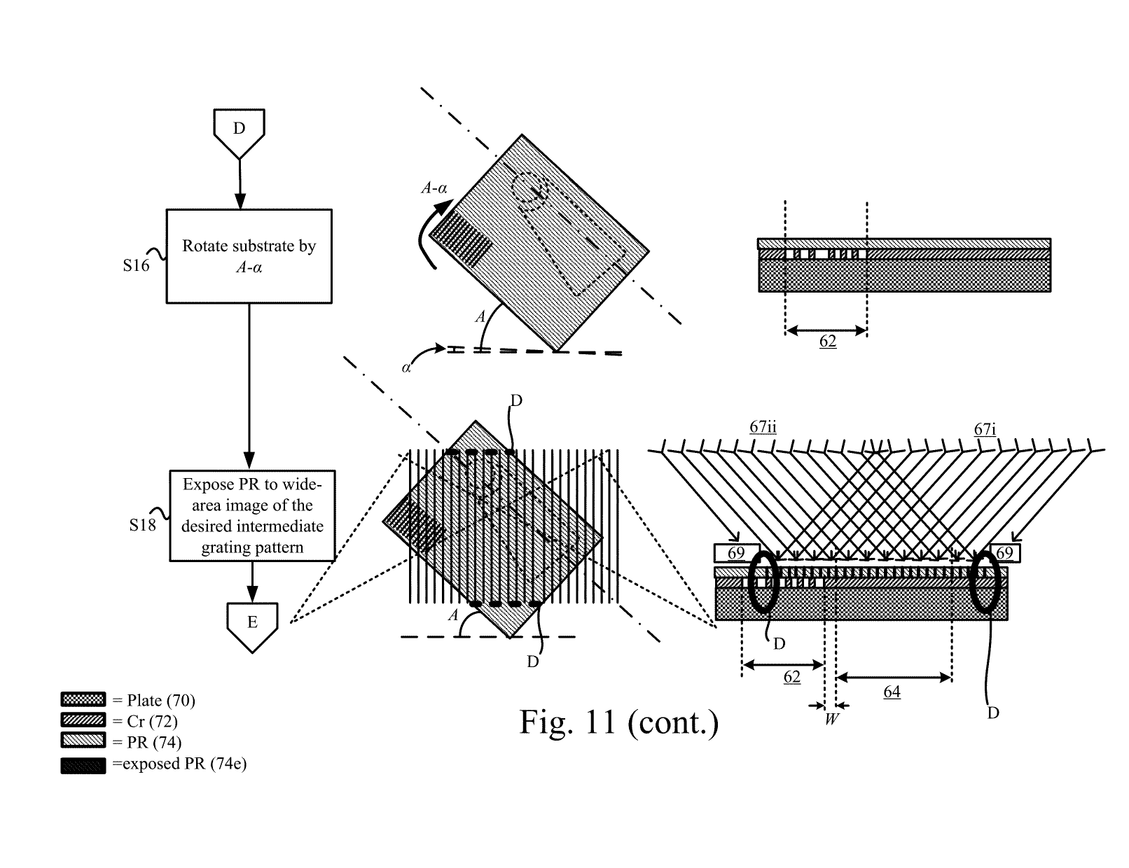

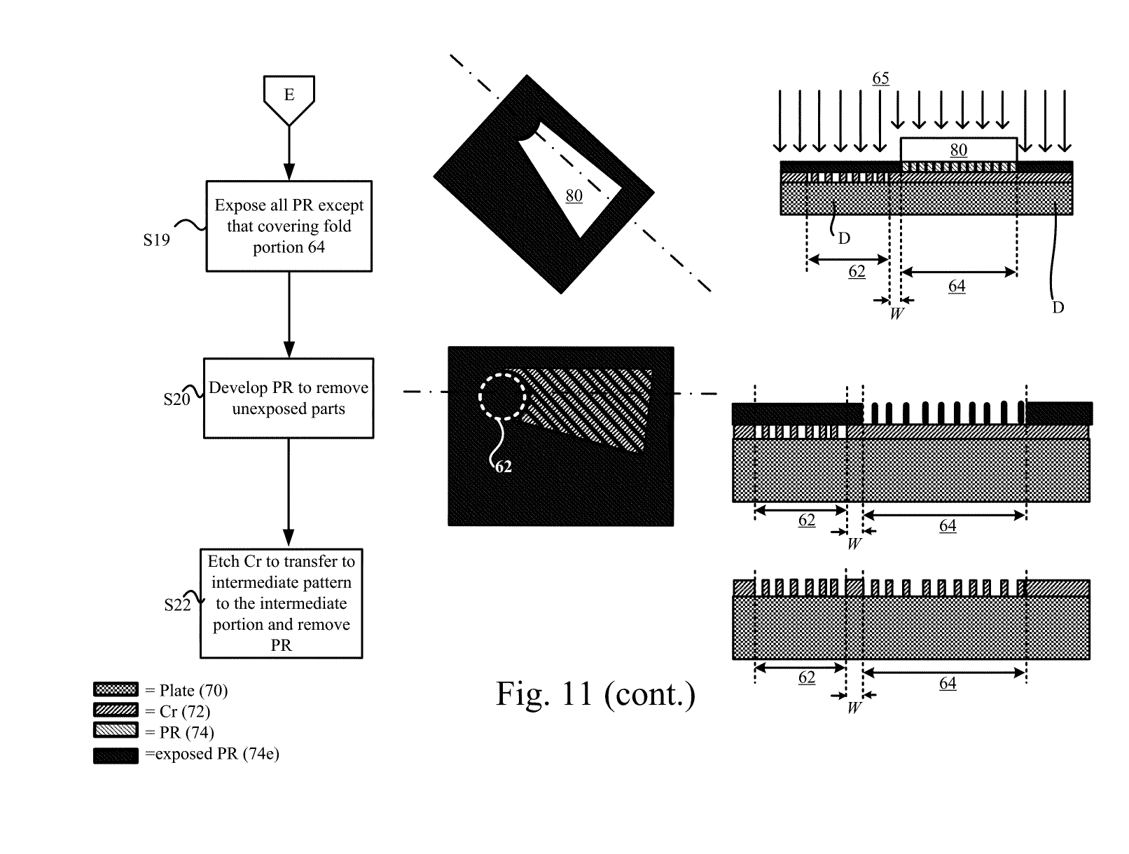

A microfabrication process for making an optical component will now be described with reference to FIG. 11. As will become apparent in view of the following, the process of FIG. 11 can be used to make optical components of the type shown in FIG. 3B with the requisite small spacing between incoupling and fold zones, which are free from edge distortion, and which moreover exhibit the desired angular orientation to a high level of accuracy.

That is, this disclosure provides a novel interference lithographic method, which enables grating to be manufactured on the surface of an optical component that are spaced apart from one another by 100 micrometers or less. This is not achievable typically achievable with traditional interference lithographic methods.

FIG. 11 shows on the left-hand side a flow chart for the process and on the right-hand side, for each step of the process, plan and/or side views of an exemplary master plate 70 as appropriate to illustrate the manner in which the plate 70 is manipulated at that step. Each side view is a cross-section taken along the dash-dotted line shown in the corresponding plan view.

An upper part of the plate's surface is coated with a chromium film 72. The plate 70 and film 72 constitute a substrate, a desired surface region of which (specifically, the surface region defined by the chromium layer 72 in this example), in performing the process, is selectively etched to create incoupling and fold SRGs 52, 54. The incoupling SRG 52 is fabricated on a first portion 62 of the desired surface region (incoupling portion), and the fold SRG 54 on a second distinct (i.e. non-overlapping) and substantially contiguous portion 64 of the desired surface region (fold portion) having the reduced separation W≦Wₘₐₓ along the (intended) common border 19. For the optical component 10 shown in FIGS. 3A and 3B, the desired region corresponds to the rear of the component's surface from the perspective of the wearer.

The final etched substrate constitutes an optical component which may be incorporated in a display system (e.g. the display system 2 of FIG. 1), or which may be for use as a production master for manufacturing further optical components e.g. a mould for moulding such components from polymer (or indeed which may be used for making such moulds), in which case the SRGs 52, 54 as fabricated on the substrate's surface are transferred to (the rear of) those components by the manufacturing e.g. moulding process.

At step S4 of FIG. 11, the chromium layer 72 is coated in a negative photoresist film 74—that is, photoresist which becomes undevelopable when exposed to light i.e. photoresist which has a composition such that those parts which have been exposed to light (and only those parts) become substantially insoluble in a developing fluid used to develop the photoresist once exposed so that the exposed parts (and only the parts) remain post-development. This includes coating the incoupling portion 62 which is ultimately intended to be patterned with the incoupling SRG 52, as well as the fold portion 64 ultimately intended to be patterned with the fold SRG 54.

At step S6, an area substantially larger than and encompassing the incoupling portion 62 is exposed (shown in this example as a rectangle containing the desired circular area 62) to light which forms the desired incoupling grating structure (i.e. that of SRG 52). By directing two laser beams 67i, 67ii to coincide in an interference arrangement, an interference pattern which forms the desired incoupling grating structure, having a grating period d when incident on the photoresist 74, is created. The interference pattern comprises alternating light and dark bands, whereby only the parts of the photoresist on which the light bands fall are exposed (exposed photoresist is shown in black and labelled 70e in FIG. 11); however, in contrast to positive photoresist, it is these exposed parts 70e which become undevelopable whereas the non-exposed parts in the locations of the dark bands remain developable.

A shadow mask 69 is used to restrict the interference pattern to the larger area. The larger area is large enough not only to encompass the incoupling surface portion 62 but also such that all the edge distortion D created by the shadow mask lies outside of the incoupling portion 62 (in general, it is sufficient for the wider area to be such there is substantially no edge distortion in the vicinity of the intended common border 19, even if there is some edge distortion present elsewhere around the edge of the incoupling portion 62).

A dummy grating portion 63 is also exposed to the same (or a similar) interference pattern at the same time for reasons that will be discussed in due course.

The exposed portions 62, 63 can be practically of any shape or size but the excess exposure resulting from possible other exposures must not reach any “active part” of the desired exposure portions (i.e. in the illustration aside S6, other exposures must not overlap the circular incoupling portion 62).

As an alternative to using masks, the interference pattern could be projected over the whole of the desired surface region so that no shadowing effects are present on the desired surface region at all.

During the exposure step S6, the plate 70 is supported by a mechanical clamping or other fixing method in an laser interference exposure setup (exposure system) not shown in FIG. 11 to hold it steady relative to the exposure system (in particular, relative to the beams 67i, 67ii) whilst the exposure takes place. After step S6, the master plate 70 is unloaded from the laser interference exposure setup.

At step S8, the unloaded plate 70 is exposed to light 65 of substantially uniform intensity, but with photo mask 80 in place to expose photoresist and thus avoid photoresist development from areas outside the incoupling and dummy grating areas 62, 63. That is, photo mask 80 on the incoupling portion 62 and the dummy region 63 are used to prevent exposure of the portions 62, 63 to the uniform light 65. Thus, uniform light 65 is projected over the entirety of the desired surface region but for the incoupling and dummy portions (as these are covered by the photo mask 80) so that all of the photoresist other than that covering the incoupling and dummy portions 62, 63 becomes undevelopable throughout. It is thus the photo mask which define the portions 62, 63 (i.e. the portions 62, 63 have the same size and shape as the corresponding photomask 80 used to protect those portions), and not the shadow masks used in S6. A mask aligner is used to position the photo mask 80 accurately on correct position on the substrate. The mask aligner has components (e.g. ultraviolet-lamp, optics etc.) for generating uniform light for exposure and the mechanics for positioning the photomask 80 to the correct position.

As will be apparent, the only photoresist to retain any record of the grating structure(s) as projected at S6 is that which covers the incoupling and dummy portions—outside of those portions, all record of the grating structure(s) is intentionally destroyed. The entirely exposed photoresist outside of the incoupling and dummy portions 62, 63 includes all the parts of the photoresist that were subjected to the edge distortion D, thus completely removing any record of the edge distortion from the photoresist. Due to the nature of the process, there is virtually no distortion to the grating pattern.

At step S10, the photoresist is developed to embody the incoupling SRG grating structure by removing only those parts of that photoresist that have not been exposed to light using a developing fluid. All the exposed, undevelopable photoresist 74e is left substantially unchanged by the development of step S10. As illustrated in the figures to the right of S10 in FIG. 11, substantially no photoresist outside of the portions 62, 63 is removed in step S10; the only removed photoresist is lines of unexposed photoresist in the incoupling and dummy portions 62, 63 corresponding to the locations of the dark bands of the interference pattern as projected on the photoresist at S6.

At step S11, a chromium etching procedure is performed to etch the chromium layer 72 (but not the plate 70 itself) with the incoupling SRG pattern, such as dry etching of the chrome hard mask 72. In etching step S11, the photoresist serves as an etching mask to restrict etching of the chromium layer 72 to the incoupling and dummy grating surface portions only, whereby structure is imposed from the photoresist to the incoupling and dummy portions 62, 63. However, the exposed, undeveloped photoresist 74e outside of the portions 62, 63 inhibits etching outside of those portions 62, 63 so that no structure is imposed on the chromium 72 outside of those portions 9 (i.e. outside of those portions, the chromium is substantially unchanged).

Once the chromium 72 has been etched thus, the exposed photoresist 74e is removed (S12) and the chromium 72 recoated with fresh, unexposed negative photoresist 74 (S13).

As indicated above, the relative orientation angle between incoupling and fold SRGs is intended to be A as defined in equation (11) above and shown in FIG. 9B (with the incoupling and exit SRGs having a relative orientation angle 2A, as per equation (12)). This can be achieved by re-loading the plate 70 in the same exposure system (previously used at S6) supported again by the same mechanical clamps or other fixing method, and rotating the plate 70 by an amount that matches A relative to the exposure system so that any subsequently projected pattern is oriented to the original incoupling SRG pattern by A (S14). By using a suitable drive mechanism, it is possible to achieve highly accurate rotation of the plate 70.

However, due to inaccuracy of mechanical stoppers, the position of the plate 70 is not accurately the same as in step S6. This is illustrated in the plan view aside step S14 of FIG. 11, in which an angle α is shown to denote slight rotation relative to the plate's initial orientation at the previous exposure step S6 caused by unloading/reloading of the plate 70.

For this reason, prior to rotating the plate 70 at S14, the offset a between the plate position in S6 and S14 is first measured. The measurement is done using a fringe pattern 81. The fringe pattern 81 changes when the plate is rotated and this can be used to measure the angle of the plate with better than 0.001 degrees resolution.

To create the fringe pattern 81, the dummy grating portion is re-exposed to the same interference pattern it was exposed to at step S6 (or at least an interference pattern having the same angular orientation), as shown on the right-hand side of FIG. 11. The fringe pattern is evident notwithstanding the presence of the photoresist atop the dummy grating. The fringe pattern is created as a result of the interaction between the interference pattern and the dummy grating, and when the angular alignment is better than e.g. 0.01 degrees, has a fringe spacing—typically of the order of few mm—and thus clearly visible when the offset a is about 5 thousandths of a degree, and which increases as a is reduced towards zero, becoming maximal (effectively infinite) upon a reaching zero. The fringe spacing is determined by the offset a and, conversely, can be used to measure a.

This leaves the photoresist atop the dummy grating partially exposed; as will become apparent, this is inconsequential. Notably, the dummy grating portion 63 is sufficiently offset from the fold grating portion 64 for the photoresist atop the fold grating portion to remain unexposed in creating the fringe pattern 81.

Once a has been measured, at step S16 the plate 70 is rotated from that initial orientation by an amount=A−α (thereby accounting for α in the rotation) so that the plate 70 now has an orientation A relative to its initial position at S6 to a high level of accuracy.

At step S18, an area substantially larger than and encompassing the fold portion 64 is exposed (shown in this example as a rectangle containing the desired area 64) again by directing two laser beams 67i, 67ii to coincide in an interference arrangement, leaving the parts of the photoresist on which light bands fall undevelopable in a manner equivalent to S6 (but without any additional dummy grating area being exposed). In S18, the interference pattern has a period d/(2 cos A) when incident on the photoresist. A shadow mask 69 is again used to restrict the interference pattern to this area, which is large enough not only to encompass the fold surface portion 64 but also such that all the edge distortion D created by the shadow mask lies outside of the incoupling portion 62 (or at least clear of the common border 16).

Some or all of the photoresist atop the incoupling grating will likely be exposed at S18, which is inconsequential as it has no effect on the incoupling pattern which has already been etched into the underlying chromium 72.

All other areas except fold portion 64 are then exposed (S19) to uniform light 65 with a suitable photo mask 80 in place to prevent exposure of the fold portion 64 (and only that portion) in a manner equivalent to step S8. This leaves all the photoresist covering the incoupling portion 62 (and also that covering an exit portion ultimately intended to be etched to form the exit grating 56) exposed and therefore undevelopable. The photoresist is then developed to remove only the unexposed parts (S20) in a manner equivalent to step S10, the chromium one again etched to transfer the fold SRG pattern from the photoresist to the chromium, and the photoresist removed following etching (equivalent to S11-S12). The incoupling portion is protected by the exposed and therefore undeveloped photoresist 70e, thereby preserving the incoupling grating pattern already etched into the chromium.

The use of photo mask 80 to define the incoupling and fold portions enables the location of the DOE areas to be controlled far more accurately then when simply using shadow masks to define those areas (as in the positive photoresist technique outlined above). It thus becomes possible to reduce the separation of those portions to W≦Wₘₐₓ whilst still retaining separation of those portions (i.e. without the etched patterns overlapping).

Although not shown explicitly in FIG. 11, it will be apparent that the chromium covering the grating area ultimately intended for the exit SRG 56 (vertically below the incoupling and fold SRGs 52, 54) is unaffected by the etching of both S11 and S22 as in both of those steps it is protected by undeveloped photoresist.

A similar process could be repeated to etch the desired fold grating structure into the chromium, again using a fringe pattern to achieve a highly accurate angular orientation of 2A between the incoupling and exit grating structures. The exit grating in the present configuration is relatively far away from the input grating. Thus input grating and exit grating can be exposed to the same photoresist layer with large enough shadow masks to avoid edge distortions.

Once all three structures have been etched into the chromium, the plate 70 itself is subject to an etching procedure (e.g. ion-beam etching) in which the chromium now serves as an etching mask, whereby the grating structures are transferred from the etched chromium 72 to the plate 70 itself to form the desired incoupling, exit and fold SRGs 52, 54, 56 on the plate itself with very good angular accuracy, narrow gap W≦Wₘₐₓ between SRgs 52, 54, and good quality edges free form edge distortion.

Note that the dummy grating pattern is not etched onto the plate itself as it is not desired on the final optical component.

Once the plate itself has been etched, the chromium is removed and the plate 70, can e.g. be used in a display system of the kind shown in FIG. 1, to mould further optical components, or indeed to make such moulds.

It has been demonstrated that, using the process of FIG. 11, substrates can be patterned, free from edge distortion, with the actual relative orientation angle between the incoupling and fold zones 14, 16 consistently being arccos(d₁/(2d₂)) (see equations 11, 12 above) and/or one half of the relative orientation angle between the incoupling and exit SRGs 12, 16 (see equation 13, above) to within ±one thousandth of a degree (as measured from a representative statistical population of substrates fabricated using the present techniques). However two thousandths of a degree may be still acceptable angular error in some practical contexts.

Whilst the above uses a dummy grating for re-alignment, it is possible in other embodiments to use the exit grating for re-alignment. The input and exit grating are in practice done without taking the plate out of the sample holder in laser system because they are ˜one centimeter apart and thus enable easy shadowing with standard mask. The exit grating is relatively large and thus a fraction of it (which is far enough away from fold grating) could be used for re-alignment when the plate is inserted back in the laser system for fold grating interference exposure.

Whilst in the above an intermediate metallic layer is deposited between the master plate and the substrate, a photoresist layer may alternatively be applied to the substrate directly and selective regions of the photoresist so that the photo resist functions in a similar manner to the aforementioned mask. However, using a separate metallic mask layer can facilitate better selectivity of etching.

Note that, whilst the process of FIG. 11 is described with reference to etching, the techniques can be adapted to effect patterning by way of deposition instead in a manner that will be apparent.

According to a first aspect, a display system comprising an optical waveguide and a light engine is provided. The optical waveguide has an incoupling grating, an intermediate grating and an exit grating. The light engine is configured to generate multiple input beams. Each beam is substantially collimated and directed to the incoupling grating in a unique inward direction, whereby the multiple input beams form a virtual image. The intermediate and exit grating have widths substantially larger than the beams' diameters. The incoupling grating is arranged to couple each beam into the intermediate grating, in which that beam is guided onto multiple splitting regions of the intermediate grating in a direction along the width of the intermediate grating. The intermediate grating is arranged to split that beam at the splitting regions to provide multiple substantially parallel versions of that beam. Those multiple versions are coupled into the exit grating, in which the multiple versions are guided onto multiple exit regions of the exit grating. The exit regions lie in a direction along the width of the exit grating. The exit grating is arranged to diffract the multiple versions of that beam outwardly. The multiple input beams thus cause multiple exit beams to exit the waveguide which form a version of the virtual image. The incoupling and intermediate gratings are substantially contiguous, separated by no more than 100 micrometres (and optionally no more than 50 micrometres) in width along a common border.

According to a second aspect, an optical waveguide for a display system which has an incoupling grating, an intermediate grating and an exit grating is provided. The incoupling grating is arranged to receive multiple input beams, each beam being substantially collimated and directed to the incoupling grating in a unique inward direction, whereby the multiple input beams form a virtual image. The intermediate and exit grating have widths substantially larger than the beams' diameters. The incoupling grating is arranged to couple each beam into the intermediate grating, in which that beam is guided onto multiple splitting regions of the intermediate grating in a direction along the width of the intermediate grating. The intermediate grating is arranged to split that beam at the splitting regions to provide multiple substantially parallel versions of that beam which are coupled into the exit grating, in which the multiple versions are guided onto multiple exit regions of the exit grating, the exit regions lying in a direction along the width of the exit grating. The exit grating is arranged to diffract the multiple versions of that beam outwardly, the multiple input beams thus causing multiple exit beams to exit the waveguide which form a version of the virtual image. The incoupling and intermediate gratings are substantially contiguous, being separated by no more than 100 (and optionally no more than 50 micrometres) micrometres in width along a common border.

In embodiments, the incoupling and intermediate gratings may exhibit substantially no edge distortion at least in the vicinity of the common border.

The incoupling and intermediate gratings may have a relative orientation angle that is one half that between the incoupling and exit gratings to within two thousandths of a degree, and possibly to within one thousandth of a degree.

The incoupling grating may have a grating period d₁, the intermediate grating may have a grating period d₂, and the incoupling and intermediate gratings may have a relative orientation angle that is arccos(d₁/(2d₂)) to within two thousandths of a degree, and possibly to within one thousandth of a degree.

The common border may be arcuate, the incoupling and intermediate gratings having edges that are arcuate along the common border. For instance, the common border may substantially semi-circular, the edges of the incoupling and intermediate gratings being substantially semi-circular along the common border. For instance, the edge of the incoupling grating may be substantially circular.

The intermediate grating may have a height that increases in a direction along its width and away from the incoupling grating.

The display system of the first aspect may be wearable by a user. For example, the display system may be embodied in a wearable headset, the exit grating positioned forward of an eye of the user when worn to make the image visible to the user.

The display system may comprise two such optical waveguides, each of which provides image light to a different eye of the user.

According to a third aspect a microfabrication process for making an optical component comprises a patterning stage in which one or more portions of a substrate's surface are patterned by performing at least the following steps. At least a region of the substrate's surface is coated in negative photoresist, the region encompassing said portions. The negative photoresist becomes undevelopable when exposed to light. Light which forms a grating structure is projected over each of the portions. Light of substantially uniform intensity is projected over the entirety of the region but for the portions, thereby leaving the negative photoresist outside of the portions undevelopable. The negative photoresist is developed so as to embody the grating structure in the photoresist covering the portions. The substrate's surface is patterned to impose the grating structure on the substrate's surface from the developed photoresist; the undevelopable photoresist inhibits patterning of the surface region outside of the portions. The optical component comprises the patterned substrate.

In embodiments the microfabrication process may comprise a first such patterning stage followed by a second such patterning stage, wherein a second grating structure imposed on the substrate's surface at the second stage is offset from a first grating structure imposed on the substrate's surface at the first stage by a non-zero angle.

The projecting steps of the first stage may be performed with the substrate supported in a first orientation in an exposure system, and the second stage may comprise: prior to the projecting steps of the second stage, rotating the substrate relative to the exposure system to a second orientation before performing the projecting steps of the second stage, wherein the second orientation is offset from the first orientation by said non-zero angle.

The substrate may be removed from the exposure system following the projecting steps of the first stage and re-loaded in the exposure system prior to performing the projecting steps of the second stage, and the second stage may comprise: after re-loading the substrate but before rotating the substrate to the second orientation, creating a fringe pattern by projecting light which forms a grating structure onto a portion of the substrate's surface already patterned at the first stage, wherein the fringe pattern is used when rotating the substrate to the second orientation to account for any unintended rotation of the substrate away from the first orientation caused by removing and re-loading the substrate.

The first grating structure may have a period different from the second grating structure.

A first portion may be patterned at the first stage with the first grating structure and a second portion patterned at the second stage with the second grating structure have a common border, wherein at the first stage a first shadow mask is used to restrict light which forms the first grating structure to a first area larger than and encompassing that first portion, wherein at the second stage a second shadow mask is used to restrict light which forms the second grating structure onto a second area larger than and encompassing that second portion, and wherein the first and second areas are large enough that those first and second portions are free from edge distortion created by the first and second mask respectively at least in the vicinity of the common border.

The first and second portions may be separated by no more than 50 micrometres in width along the common border.

For at least one of the portions, a shadow mask may be used in the first projecting step to restrict the light which forms a grating structure to an area larger than and encompassing that portion, the area sufficiently large for that portion to be entirely free from edge distortion created by the mask.

The substrate may initially comprises a master plate on which a metallic film is deposited, wherein the metallic film is patterned in the patterning step of the third aspect to impose the grating structure on the metallic film from the photoresist.

The process may comprise patterning the plate to impose the grating structure on the plate from the metallic film, and subsequently removing the metallic film, wherein the optical component comprises the patterned plate with the metallic film removed.

The common border may be arcuate. For example, one of said first and second portions may be substantially circular.

One of said first and second portions may have a height that increases in a direction along its width and away from the other of said first and second portions.

An optical component, made according to any manufacturing process disclosed herein, may itself be used to make at least one further optical component. The further optical component may for instance be moulded from polymer using the optical component.

The further optical component may be for use in a display system.

A fourth aspect provides a product made by any of the manufacturing processes disclosed herein.

The further optical component may be used to make at least one yet further optical component. The yet further optical component may for instance be moulded from polymer using the further optical component.

According to a fifth aspect an optical component has a first and a second diffraction grating, the first grating formed by a first series of substantially parallel, elongate grooves in a first portion of the optical component's surface, the second grating formed by a second series of substantially parallel, elongate grooves in a second portion of the optical component's surface distinct from the first portion. The second grating is offset from the first grating by a non-zero angle. The first and second portions are substantially contiguous, separated by no more than 100 micrometres (optionally 50 micrometres) in width along a common border. The first and second gratings exhibit substantially no edge distortion at least in the vicinity of the common border.

A display system comprising a display, an optical waveguide and collimating optics is provided. An image is generated on the display. The optical waveguide has an incoupling grating, an intermediate grating and an exit grating. The collimating optics is arranged to substantially collimate the image into multiple input beams. Each beam is formed by collimating light from a respective image point, that beam directed to the incoupling grating in a unique inward direction which depends on the location of that point in the image. The multiple input beams thus forming a virtual version of the image. The intermediate and exit grating have widths substantially larger than the beams' diameters. The incoupling grating is arranged to couple each beam into the intermediate grating, in which that beam is guided onto multiple splitting regions of the intermediate grating in a direction along the width of the intermediate grating. The intermediate grating is arranged to split that beam at the splitting regions to provide multiple substantially parallel versions of that beam. Those multiple versions are coupled into the exit grating, in which the multiple versions are guided onto multiple exit regions of the exit grating. The exit regions lie in a direction along the width of the exit grating. The exit grating is arranged to diffract the multiple versions of that beam outwardly, substantially in parallel and in an outward direction which substantially matches the unique inward direction in which that beam was incoupled. The multiple input beams thus cause multiple exit beams to exit the waveguide which form substantially the same virtual version of the image. The incoupling and intermediate gratings are substantially contiguous, separated by no more than 100 micrometres (and optionally no more than 50 micrometres) in width along a common border.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A display system comprising:
an optical waveguide having an incoupling grating, an intermediate grating and an exit grating; and
a light engine configured to generate multiple input beams, each beam being substantially collimated and directed to the incoupling grating in a unique inward direction, whereby the multiple input beams form a virtual image;
wherein the intermediate and exit grating have widths substantially larger than the beams' diameters;
wherein the incoupling grating is arranged to couple each beam into the intermediate grating, in which that beam is guided onto multiple splitting regions of the intermediate grating in a direction along the width of the intermediate grating;
wherein the intermediate grating is arranged to split that beam at the splitting regions to provide multiple substantially parallel versions of that beam which are coupled into the exit grating, in which the multiple versions are guided onto multiple exit regions of the exit grating, the exit regions lying in a direction along the width of the exit grating;
wherein the exit grating is arranged to diffract the multiple versions of that beam outwardly the multiple input beams thus causing multiple exit beams to exit the waveguide which form a version of the virtual image; and
wherein the incoupling and intermediate gratings are substantially contiguous, separated by no more than 100 micrometres in width along a common border.

2. A display system according to claim 1 wherein the incoupling and intermediate gratings exhibit substantially no edge distortion at least in the vicinity of the common border.

3. A display system according to claim 2 wherein the incoupling and intermediate gratings have a relative orientation angle that is one half that between the incoupling and exit gratings to within two thousandths of a degree.

4. A display system according to claim 3 wherein the relative orientation angle between the incoupling and intermediate gratings is one half that between the incoupling and exit grating to within one thousandth of a degree.

5. A display system according to claim 2 wherein the incoupling grating has a grating period d₁, the intermediate grating has a grating period d₂, and the incoupling and intermediate gratings a relative orientation angle that is arccos(d₁/(2d₂)) to within two thousandths of a degree.

6. A display system according to claim 5 wherein the relative orientation angle between the incoupling and intermediate gratings is arccos(d₁/(2d₂)) to within one thousandth of a degree.

7. A display system according to claim 1, wherein the common border is arcuate, the incoupling and intermediate gratings having edges that are arcuate along the common border.

8. A display system according to claim 7, wherein the common border is substantially semi-circular, the edges of the incoupling and intermediate gratings being substantially semi-circular along the common border.

9. A display system according to claim 8, wherein the edge of the incoupling grating is substantially circular.

10. A display system according to claim 1, wherein the intermediate grating has a height that increases in a direction along its width and away from the incoupling grating.

11. A display system according to claim 1, which is wearable by a user.

12. A display system according to claim 11 embodied in a wearable headpiece, the exit grating positioned forward of an eye of the user when worn to make the image visible to the user.

13. A display system according to claim 12 comprising two such optical waveguides, each of which provides image light to a different eye of the user.

14. A display system according to claim 1, wherein the waveguide is substantially flat so as to outwardly diffract the multiple versions of each beam substantially in parallel to one another and in an outward direction which substantially matches the unique inward direction in which that beam was incoupled.

15. A display system according to claim 1, wherein the waveguide is curved so as to form the virtual image a finite distance from the waveguide.

16. A display system according to claim 1 wherein the incoupling and intermediate gratings are separated by no more than 50 micrometres in width along the common border.

17. An optical waveguide for a display system, the optical waveguide having an incoupling grating, an intermediate grating and an exit grating, the incoupling grating arranged to receive multiple input beams, each beam being substantially collimated and directed to the incoupling grating in a unique inward direction whereby the multiple input beams form a virtual image;
wherein the intermediate and exit grating have widths substantially larger than the beams' diameters;
wherein the incoupling grating is arranged to couple each beam into the intermediate grating, in which that beam is guided onto multiple splitting regions of the intermediate grating in a direction along the width of the intermediate grating;
wherein the intermediate grating is arranged to split that beam at the splitting regions to provide multiple substantially parallel versions of that beam which are coupled into the exit grating, in which the multiple versions are guided onto multiple exit regions of the exit grating, the exit regions lying in a direction along the width of the exit grating;
wherein the exit grating is arranged to diffract the multiple versions of that beam outwardly the multiple input beams thus causing multiple exit beams to exit the waveguide which form a version of the virtual image; and
wherein the incoupling and intermediate gratings are substantially contiguous, separated by no more than 100 micrometres in width along a common border.

18. An optical waveguide according to claim 17, wherein the incoupling and intermediate gratings exhibit substantially no edge distortion in the vicinity of the common border.

19. An optical waveguide according to claim 17, wherein the incoupling and intermediate gratings have an orientation angle that is one half that of the incoupling and exit gratings to within one thousandth of a degree.

20. A display system comprising:
a display on which an image is generated;
an optical waveguide having an incoupling grating, an intermediate grating and an exit grating; and
collimating optics arranged to substantially collimate the image into multiple input beams, each beam formed by collimating light from a respective image point, that beam directed to the incoupling grating in a unique inward direction which depends on the location of that point in the image, the multiple input beams thus forming a virtual version of the image;
wherein the intermediate and exit grating have widths substantially larger than the beams' diameters;
wherein the incoupling grating is arranged to couple each beam into the intermediate grating, in which that beam is guided onto multiple splitting regions of the intermediate grating in a direction along the width of the intermediate grating;
wherein the intermediate grating is arranged to split that beam at the splitting regions to provide multiple substantially parallel versions of that beam which are coupled into the exit grating, in which the multiple versions are guided onto multiple exit regions of the exit grating, the exit regions lying in a direction along the width of the exit grating;
wherein the exit grating is arranged to diffract the multiple versions of that beam outwardly, substantially in parallel and in an outward direction which substantially matches the unique inward direction in which that beam was incoupled, the multiple input beams thus causing multiple exit beams to exit the waveguide which form substantially the same virtual version of the image;
wherein the incoupling and intermediate gratings are substantially contiguous, separated by no more than 50 micrometres in width along a common border;
wherein the incoupling and intermediate gratings exhibit substantially no edge distortion in the vicinity of the common border; and
wherein the incoupling and intermediate gratings have a relative orientation angle that is one half that between the incoupling and exit gratings to within two thousandth of a degree; and/or wherein the incoupling grating has a grating period d₁, the intermediate grating has a grating period d₂, and the relative orientation angle between the incoupling and exit gratings is arccos(d₁/(2d₂)) to within two thousandth of a degree.
